(19) United States
(12) Patent Application Publication
(10) Pub. No.: US 2006/0100914 A1
(43) Pub. Date: May 11, 2006

(54) System for, and method of, providing travel-related services

(76) Inventors: Vajid H. Jafri, Redwood Shores, CA (US); Mallikarjun G. Hiremani, Fremont, CA (US); James L. Martinez, Redwood City, CA (US); Sajid H. Jafri, Foster City, CA (US)

Correspondence Address: FULWIDER PATTON, 6060 CENTER DRIVE, 10TH FLOOR, LOS ANGELES, CA, 90045, US

(21) Appl. No.: 11/103,014

(22) Filed: Apr. 11, 2005

Related U.S. Application Data
(63) Continuation-in-part of application No. 10/027,477, filed on Dec. 21, 2001.
Application No. 10/027,477 is a continuation-in-part of application No. 10/010,300, filed on Dec. 5, 2001.

(51) Int. Cl. G06Q 10/00

(52) U.S. Cl. 705/5

(57) ABSTRACT

Legacy transactions, and their costs, meeting specified parameters may be provided through a wide area network to a processing station (e.g. a travel agency). These parameters may be airline flights leaving on a particular day from a specified originating location to a specified destination and specifying established and published fares of primary airlines. Individual transactions (e.g., airline flights and fares) may be provided to a database at the travel agency through the internet from (a) airlines other than the primary airlines in the legacy servers, (b) the primary airlines with discounted fares, (c) consolidators offering wholesale fares and (d) an Orbitz web server. A display screen at the processing station respectively displays the legacy transactions and the other transactions on first and second portions of a display screen. The database selects one of the transactions and provides for the printing of a ticket for the selected transaction at a printer at the travel agency or a printer at the legacy server and for an accounting at the travel agency or the legacy server.

### CROSS-REFERENCES TO RELATED APPLICATIONS

This is a continuation-in-part of application Ser. No. 10/027,477 (attorney's file EXCAM-59170) filed in the United States Patent and Trademark Office (USPTO) on Dec. 21, 2001. application Ser. No. 10/027,477 is in turn a continuation-in-part application of Ser. No. 10/010,300 filed in the USPTO on Dec. 5, 2001. This application and applications Ser. Nos. 10/010,300 and 10/027,477 have been assigned of record to Cfares, Inc. (or Excambria), a corporation of the State of California.

### FIELD OF THE INVENTION

This invention relates to services and accounting within the retail and wholesale travel-related services industries. This invention further relates to a system for and a method of gathering offers of travel services from each of multiple travel service suppliers and their agents and making travel-related decisions based upon these offers.

### BACKGROUND OF THE INVENTION

The primary airlines (e.g. American, United and Delta) have handled bookings for their flights on legacy servers which have been identified by the trademarks “Sabre®”, “Galileo®”, “Amadeus®” and “Worldspan®”. The primary airlines provide established and published flight schedules and fares for their flights in these legacy servers. The legacy servers transmit these airline flights and fares through a wide area network to processing stations (e.g. travel agencies). Travel agents at the travel agencies obtain flight and fare information for their clients at processing stations at the travel agencies. The travel agents receive commissions when they book flights through the legacy servers. However, recently the primary airlines providing flight and fare information to the legacy computers have reduced the amount of the commissions paid to travel agents when the travel agents book the flights.

A number of airlines are not in the legacy servers. They include Southwest Airlines and America West Airlines. Tickets on these airlines can be obtained by telephone calls either from the travel agent or the client. Furthermore, the airlines provide for purchasers of tickets on the internet through Orbitz®. Orbitz offers tickets at reduced prices. These reduced prices are below the established and published prices which are provided in the legacy servers of the primary carriers, but these discounts are generally only for flights in the near future and are often at the least desirable hours, such as late at night. Consolidators also purchase blocks of tickets from the airlines at wholesale prices and offer theses tickets through telephone lines to passengers generally at prices above the wholesale prices but below the retail price established and published by the airlines.

As will be seen from the above discussion, there are a number of different ways for a passenger to purchase airplane tickets. Some of these are at established and published retail prices. Others of these are at discounted prices. Some of these are available to travel agents and others are not. It would be desirable for travel agents to be accessible to all of these different ways of purchasing airline tickets. It would also be desirable for the travel agents to be able to offer to a client, with a minimal amount of effort, the optimal travel time for the client on a specified date at the lowest price on an airline acceptable to the client to travel from a specific originating location to a specific destination.

The following is the “Background” from the parent application Ser. No. 10/010,300:

The commercial sector of the Web has been extensively used for direct sales of travel services. At the consumer or end-user level, systems and methods for conducting e-commerce typically involve a computer running a web browser for accessing web pages from remote servers via the one and only, well-known, internet. Computerized travel booking services, especially for air travel, have become more complex with the rise in popularity of the internet. Not only are there many more sources of services but terms and conditions are increasingly complex. A need to manage the various complexities on a single client computer exists. Sales and ancillary sales support activity (such as ticketing) within the travel-related industry are typified or dominated by an airline or other component. Thus the airline component services of the travel-related industry is paradigmatically used and envisioned in accompanying diagrams. A small number of online services provide a large proportion of air travel fares quotation and ordering for air travel booked by travel agents for clients. There are four such online services: they are known by their trade names, Sabre®, Worldspan®, Galileo®, and Amadeus®. These are collectively and individually known, in the art, as GDS (global distribution system(s)).

An important reason that travel agents use GDS is that they provide familiar bookkeeping arrangements, credit, ticketing, refunds and other terms and conditions. Especially, GDS generate accounting records for computerized billing systems and reports including statistics for clients. Such report keeping is of great importance to business and corporate clients.

However, the Internet and World Wide Web (“the Web”) have become everyday utilities for many businesses and individuals and often provide cheaper tickets than are available through GDS's. Under price performance pressure, travel agents scan the world wide web for better prices and then purchase tickets over the Internet. The travel agent must then typically enter the purchase into a GDS in order to generate the required accounting records. Often, too, a service charge (profit margin) must be charged separately, rather than a preferred method of bundling or commissions from the supplier. Another problem is that internet sales can often have complex and unfamiliar terms and conditions with the risk that the agent may purchase a non-refundable fare only to later notice a restriction that makes the fare useless to the client. Since the terms are not presented in a standard way, they are open to misinterpretation. Also, the agent may need authorization to advance credit (usually credit card credit) for the purchase. This can result in a dilemma for the business owner as to how much authority to spend money should be given to the agent since each situation is unique. Thus, the Internet is not as travel agent friendly as the GDS. However, sometimes travel agents must use the Internet to access websites or lose business. Websites are well known in the art.

Travel-related services are transitory. For example, if there is an empty seat in an airplane traveling between Los Angeles and New York, the lost revenue to the airline as a result of the empty seat cannot ever be recovered Airlines attempt to resolve this problem by offering reduced fares as the time for departure approaches. However, this attempt is crude and not sophisticated. One problem is that airlines cannot determine how their competitors are reducing their fares for the flight as the departure time for the flight is approaching. Furthermore, airlines cannot determine how many seats on the flights of their competitors are empty as the departure time is approaching. As will be appreciated, the pressure of the airlines to reduce prices increases as the cumulative number of empty seats in the different flights increases and as the time for the departure of the flight approaches.

### BRIEF DESCRIPTION OF A PREFERRED EMBODIMENT OF THE INVENTION

Legacy transactions, and their costs, meeting specified parameters may be provided through a wide area network to a processing station (e.g. a travel agency). These parameters may be airline flights leaving on a particular day from a specified originating location to a specified destination and specifying established and published fares of primary airlines. Individual transactions (e.g., airline flights and fares) may be provided to a database at the travel agency through the internet from (a) airlines other than the primary airlines in the legacy servers, (b) the primary airlines with discounted fares, (c) consolidators offering wholesale fares and (d) an Orbitz web server. A display screen at the processing station respectively displays the legacy transactions and the other transactions on first and second portions of a display screen. The database selects one of the transactions and provides for the printing of a ticket for the selected transaction at a printer at the travel agency or a printer at the legacy server and for an accounting at the travel agency or the legacy server.

The following constitutes the “Summary” of the invention from the parent application Ser. No. 10/010,030:

According to a first aspect of the invention, a method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen. According to a further aspect of the invention, software is provided to implement the method of the first aspect. According to a still further aspect of the invention, computers are provided to implement the method of the first aspect.

These and other features and advantages of the invention are set forth in part in the description which follows and in part will become apparent to those having ordinary skill in the art upon examination of the following or may be learned from practice of the invention. The advantages of the invention may be realized and attained as particularly pointed out in the appended claims. The embodiments described should be viewed as exemplary and enabling and disclosing best know mode rather than limiting as to the bounds of the invention.

Prices quoted by different suppliers to customers for a travel-related service are displayed on a screen. Supplier A's price quotation will be higher than supplier B's if the price quotations are not changed. However, A has previously authorized agent D to reduce the price by a specified amount when A's price quotation is greater than B's and the specified reduction would reduce A's price below B's. A's price display is accordingly reduced by the specified amount.

If C accepts A's reduced offer, C pays D the price without the specific reduction and receives from D a chit specifying a reduction which A pays C. If C refuses D's offer, A has previously authorized D to offer C upgrade(s) (e.g., business class or frequent flyer miles). If C still refuses D's offer, A has previously authorized D to offer C additional specified price reductions. It will be appreciated that D may offer C any combination of the concessions specified above.

Applicant's method provides time-related services to a recipient. Proposals are provided through a wide area network of first competitors offering to perform the travel-related services for first designated considerations in accordance with parameters provided by the recipient. Proposals are also provided through the internet of second competitors offering to perform the travel-related services for second designated considerations in accordance with the parameters provided by the recipient.

A display is provided of the travel-related services offered by the first and second competitors and the considerations quoted by them for such services A determination is made from the display whether a selected one of the competitors is at a disadvantage relative to other competitors in the consideration offered by the competitors to the recipient for the travel-related services. The selected one of the competitors then offers the recipient a change in the consideration offered by that competitor to provide an advantage to that competitor in performing the travel-related services for the passenger.

### BRIEF DESCRIPTION OF THE DRAWINGS

In the drawings:

FIG. 1 shows a high level depiction of one embodiment of an invention of the prior art;

FIG. 2 shows a high level depiction of a travel agency client computer network according to an embodiment of the invention of the prior art;

FIG. 3 schematically represents a client computer used in an embodiment of the invention of the prior art as shown in FIGS. 1 and 2;

FIG. 4 schematically represents a server computer such as may be used to implement embodiments of the invention of the prior art;

FIG. 5 shows a client computer display screen layout such as may be used in one embodiment of the invention of the prior art;

FIG. 6 shows a flow diagram of reservation functions according to an embodiment of the invention of the prior art;

FIG. 7 shows a flow diagram of accounting functions according to an embodiment of the invention of the prior art;

FIG. 8 is a schematic diagram showing in block form a system of the prior art for providing air flight and air fare information for global distribution systems (Sabre®, Worldspan®, Galileo®, and Amadeus®), major hotel chains and major car rental companies;

FIG. 9 is a schematic diagram showing in block form a system of the prior art for providing air flight and air fares for the airlines other than those shown in FIG. 7, for the car rental agencies other than those shown in FIG. 7, for the wholesale inventory of the airlines and for tour operators;

FIG. 10 is a schematic diagram showing in block form a system constituting a preferred embodiment of applicants' invention of the prior art (but claimed by applicants in another patent application) and providing for information relating to flight and fare information from the airlines, hotel chains, car rental companies and cruise line companies to be provided through the internet and a wide area network to a processing station;

FIG. 11 shows another preferred embodiment of applicant's invention of the prior art and shows in block form a combination of the blocks shown in FIGS. 8 and 10 to provide displays simultaneously on a display screen at the travel agency of the indications obtained from the blocks shown in FIGS. 8 and 10 and to provide a printing of a ticket for the trip indicated on the display screen and to provide for an accounting of the purchase of the ticket;

FIG. 12 shows another preferred embodiment of applicant's invention of the prior art, this combination being formed by the blocks shown in FIG. 8 and by a modification of the blocks shown in FIG. 10;

FIGS. 13 and 13-1 constitute a flow chart showing the operation of the system of FIG. 11 in providing a display simultaneously on the display screen at the travel agency of the flight information provided by the blocks shown in FIG. 11;

FIGS. 14-1 and 14-2 constitute a flow chart showing the operation of the system of FIG. 11 in providing an accounting, for the flight selected by the client or the travel agency, at the travel agency or at a legacy server also shown in FIGS. 8, 11 and 12;

FIG. 15 is a flow chart showing the operation of applicant's system in challenging for a first airline through price reductions and upgrades the advantages in the price quotation to a customer of a second airline relating to a proposed airline flight by the customer;

FIG. 16 is a flow chart showing the operation of applicant's system in challenging through additional price reductions the advantages in the price quotation to the customer of the second airline relating to the proposed airline flight by the customer;

FIG. 17 shows in additional detail the operation of applicant's system (shown in FIG. 15) in challenging the advantages in the price quotation to the customer of the second airline relating to the proposed airline flight by the customer;

FIG. 18 shows in additional detail the operation of applicant's system (shown in FIG. 15) for challenging the advantages in the price quotation to the customer of the second airline relating to the proposed airplane flight by the customer;

FIG. 19 shows in additional detail the operation of applicant's system (shown in FIG. 16) for challenging through the upgrades the advantages in the price quotations to the customer of the second airline relating to the proposed airplane flight by the customer;

FIG. 20 is a schematic presentation of a display of different flights meeting the needs of a customer on each of the two opposite directions on a round-trip basis and of the selection by the customer of one of the flights in each of the two opposite directions;

FIG. 21 is a schematic presentation similar to that shown in FIG. 20 of different flights meeting the needs of a customer in each of the two opposite directions on a round-trip basis and the selection by the customer of one of the flights in each of the two opposite direction with an upgrade to first class; and

FIG. 22 is a schematic presentation of a pop-up to the customer of a flight from an airline (not necessarily the first airline) with a reduced price below the prices discussed in FIGS. 15-21 if the customer is not interested in purchasing a ticket with the price reductions and upgrades as shown in FIGS. 15-21.

### DETAILED DESCRIPTION OF A PREFERRED EMBODIMENT OF THE INVENTION

The following is the “Detailed Description” from the parent application Ser. No. 10/010,300:

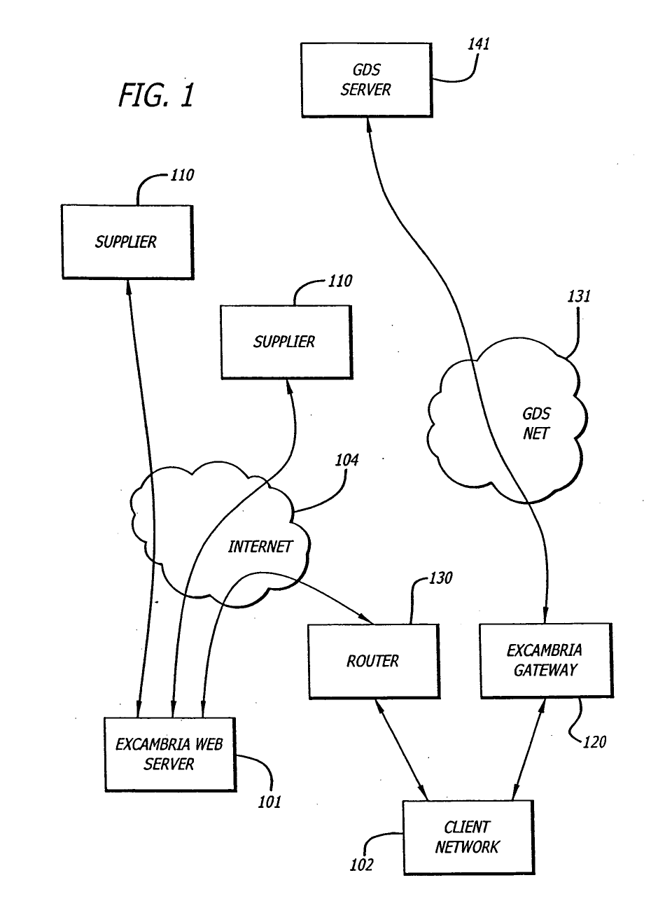

Consumer computer systems and methods are well known in the relevant arts. A high level depiction of one embodiment of the invention of the prior art is shown in FIG. 1. Box 101 relates to one or more distributed processing servers which are well understood in the art. One particular such server that has been used to embody the invention is the Cfares (or Excambria)™ Web Server 101 which is used as an example herein. The Figure depicts a travel agency client computer network 102 which may contain computer workstations (not shown in FIG. 1) that may connect though a router 130 and the Internet 104 to Cfares (or Excambria) web server 101. The well known Internet Protocol (IP) is used to communicate over the Internet which is also well known in the art. Cfares (or Excambria)™ Web Server 101 in turn connects via Internet 104 to multiple supplier server computers 110 (two shown, but typically many available). Supplier computers may typically operate as e-commerce websites, exchanging requests and responses by means of Internet oriented protocols such as FTP, HTTP, HTML, XML and/or many others. Travel agency client computer network 102 also connects through a Gateway 120 and through a proprietary GDS telecommunication network 131 to one of the several GDS Services 141 that may be available and which are typically based on mainframe computers. Presently there are four GDS Services and they are well known in the art. They are Sabre®, Worldspan®, Galileo® and Amadeus®.

Again referring to FIG. 1, examples of entities that may constitute server machines (box 101) are remote servers, auction servers, transaction servers, inventory systems, supplier managed systems, etc. Parts of the invention may incorporate (have parts that are implemented on) one or more of these example entities. The invention may also incorporate entities that are not listed herein. These entities cooperate with each other in gathering, transmitting, requesting, manipulating, etc. . . . travel related service information. The Internet Protocol (IP) is used for communication over the Internet (box 104) as is well understood in the art.

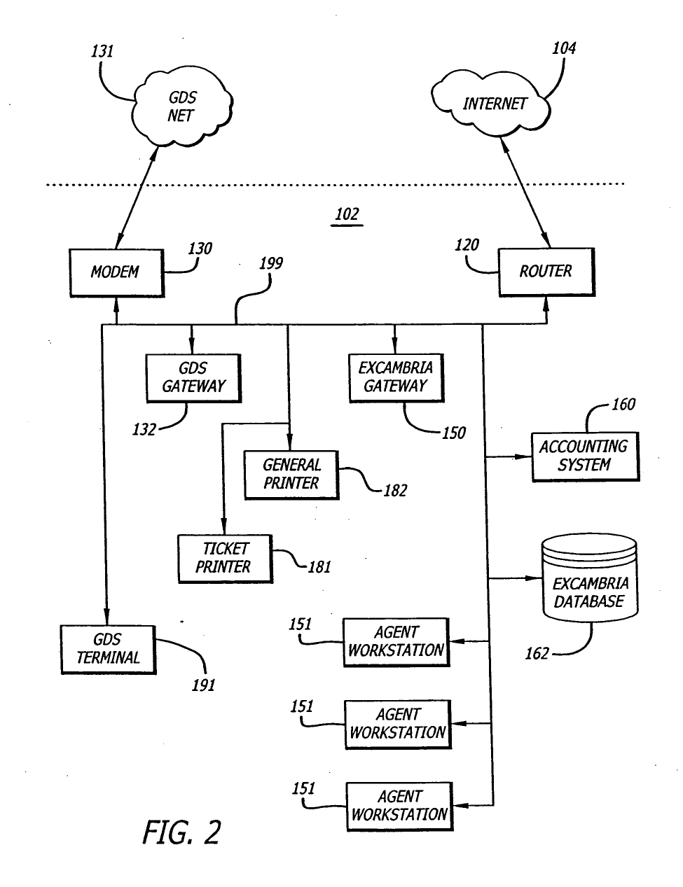

These and other features and advantages may be accomplished by the provision of alternative topologies of computer systems incorporating client computer(s), Internet server computers and GDS. FIG. 2 shows a high level depiction of a travel agency client computer network 102 according to an embodiment of the invention of the prior art. The exemplary travel agency client computer network 102 may function as depicted in FIG. 1. Still referring to FIG. 2, the travel agency client computer network 102 connects to Internet 104 and GDS proprietary network 131. Gateway Modem 130 connects GDS network 131 and Router 120 connects Internet 104. GDS network 131 provides communication to and from a GDS (not shown in FIG. 2) and Internet 104 provides communication to and from an Cfares (or Excambria) server (also not shown in FIG. 2). Various intelligent devices within the travel agency client computer network 102 interconnect, for example, by means of a LAN (local area network) 199 which may be Ethernet, Token Ring or other LAN technology. Optional GDS terminal 191 may be a retained or “legacy” device that may be used by travel agents to access GDS, for example, outside the context of the invention. GDS Gateway 132 operates on behalf of GDS terminal 191 to forward requests and responses to GDS network 131 via modem 130.

One or more agent workstations 151 are provided for individual use by travel agents; typically such workstations may be implemented as software and hardware based upon the ubiquitous PC (Personal Computer). Agent workstations 151 communicate via Cfares (or Excambria) gateway 150, LAN 199, Router 120 and Internet 104 with Cfares (or Excambria) web server computer (not shown in FIG. 2). Cfares (or Excambria) gateway 150 operates on behalf of agent workstations 151 to forward requests and responses to GDS network 131 via modem 130. The accounting system computer 160 may receive messages from many sources and maintains accounting records on an accounting database (not shown). The agent workstations 151 are typically client computers (PC) that implement Cfares (or Excambria) client programs. Agent workstations 151 may be referred to, for convenience, as communicating with a GDS, but the Cfares (or Excambria) gateway 150 receives requests and responses and forwards them to GDS from agent workstation or vice versa.

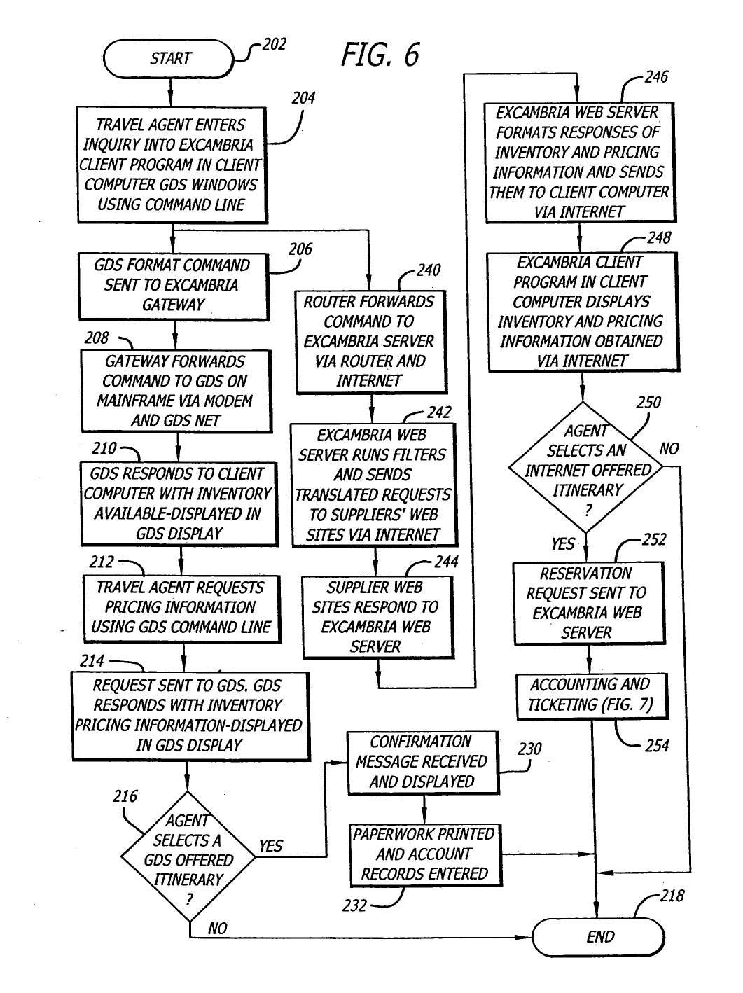

FIG. 5 shows an exemplary prior art client computer display screen 500 layout such as may be used in one embodiment of the invention. The display screen 500 is divided into areas or windows 501, 502, 503, 504 and perhaps others. In one embodiment, the large area GDS Display window 501 provides a character-oriented scrolling window as may be required by GDS for the traditional human/compute interface thereto. Thus, a terminal emulation of a real GDS terminal optionally including features such as synchronous protocol may be performed using display window 501 and a client computer keyboard. The itinerary may be captured by filtering and interpreting a GDS formatted inquiry using command line 503 in the client computer or in a Cfares (or Excambria) gateway or alternatively the itinerary may be entered directly using the human interface (e.g. keyboard) into command line 503. Various command “buttons” 505 for functions may be provided in accordance with the well known computer windows human interface. Window 502 may be used to display information such as inventory and pricing for itineraries located by a Cfares (or Excambria) web server (and other web-based content) as is discussed below.

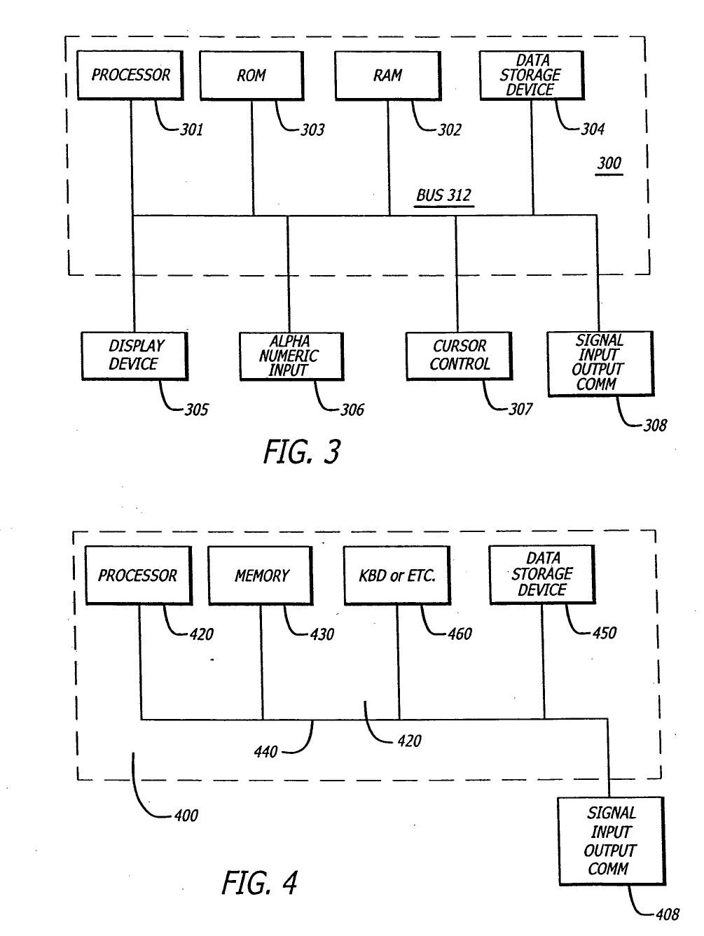

Reference is made to FIG. 3 illustrating a block diagram of a typical prior art client computer system 300 which may be implemented or practiced by using the present invention. Such a client computer system may serve as the client computer system 102 of FIG. 1. Referring again to FIG. 3, client computer system 300 is connected to the Internet (not shown expressly, but typically via data communications port 308, sometimes known as an “I/O interface”). It is to be appreciated that client computer system 300 is exemplary only and that the present invention can operate within a number of different computer systems including general purpose computer systems, embedded computer systems, and others. In the following discussions of the present invention, certain processes and steps are realized as a series of instructs (e.g., software program) that reside within computer readable memory units of system 300 and executed by processors of system 300.

In general, client computer system 300 used by the present invention comprises address/data bus 312 for conveying information and instructions, central processor (CPU) 301 coupled with bus 312 for processing information and instructions, a random access memory (RAM) 302 for storing digital information and instructions, a read only memory (ROM) 303 for storing information and instructions of a more permanent nature. In addition, client computer system 300 may also include a data storage device 304 (e.g., a magnetic, optical, floppy, tape drive, etc.) for storing vast amounts of data, and an I/O interface 308 for interfacing with peripheral devices (e.g. computer network, modem, etc.). More particularly, the memories (e.g., RAM 302, ROM 303, and data storage device 304) of client computer 300 store the instruction codes in accordance with the present invention. A person of ordinary skill in the art will understand that the memories may also contain additional information such as applications programs, network communications programs (e.g., TCP/IP protocol), operating system software, data, etc.

Moreover, client computer system 300 may include a display device 305 for displaying information to a computer user, an alphanumeric input device 306 (e.g., keyboard), and a cursor control device 307 (e.g., mouse, track-ball, light-pen, etc.) for communicating user input information and command selections. The human oriented input and output features may be collectively used as the human interface.

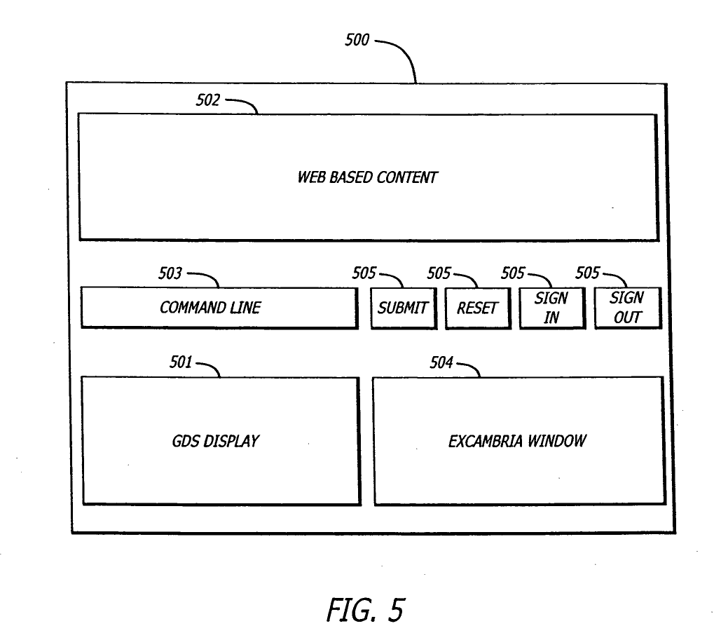

Referring to FIG. 4, server computer 400 comprises central processing CPU 420, memory 430, and communications adapter 408 which are connected together by system bus 440. Such a server computer system may serve as the Cfares (or Excambria) server computer system 101 of FIG. 1. Memory 430 stores software. It will be understood by a person of ordinary skill in the art that server computer 400 can also include other elements shown in FIG. 4 such as disk drives 450, keyboard 460, etc. A person of ordinary skill in the art will understand that memory 430 may also contain additional information such as applications programs, network communication programs (e.g., TCP/IP protocol stack), operating system software, data, etc. Client computer 300 and server computer 400 are linked together by a network, typically the Internet. Furthermore, a person of ordinary skill in the art will understand that the computer systems 300 and 400 may contain more or less than what is shown in FIGS. 3 and 4.

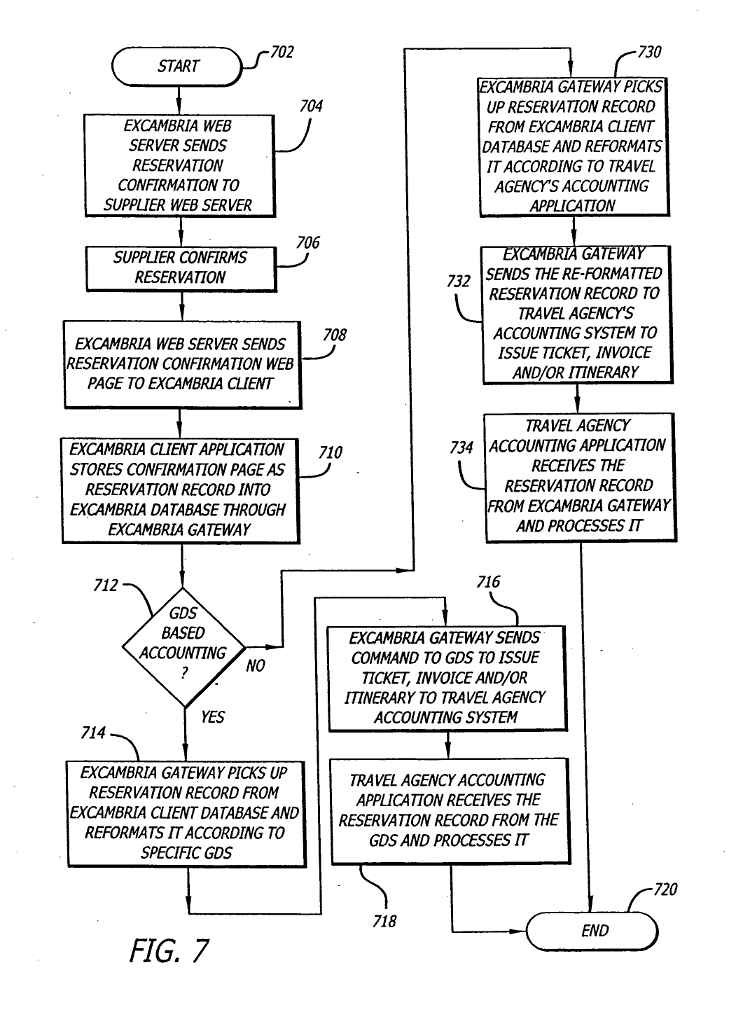

Reference is now made to FIG. 6 illustrating a flow diagram of a reservation method according to an embodiment of the invention of the prior art. The Figure effectively shows the computer implemented acts to carry out part of the embodiment of the present invention. In general, the acts in FIG. 6 are designed to implement travel agent service mechanisms. The acts in FIG. 6 are carried out when processors 301 and 420 (FIGS. 3 and 4) execute the instruction codes stored in the memory of computer systems 300 and 400 (FIGS. 3 and 4). Websites and GDS, as are well known in the art, may also perform some of the necessary functions. It is to be appreciated that the acts described herein are illustrative only and other sequences of steps could be used within the general scope of the invention.

Still referring to FIG. 6, in box 202 the method is started. In box 204, the travel agent enters an inquiry, such as for flight availability and/or pricing. The travel agent enters the inquiry into Cfares (or Excambria) client program in client computer command line window using a command line format. A traditional concise GDS format is used; for example command such as “ALAXSFO22NOV” might be used to inquire as to the availability of airline ticket for travel from Los Angeles to San Francisco on 22nd November next. The client computer software may express the inquiry as a command upon the screen. Then in box 206, the client computer software forwards the GDS format command to Cfares (or Excambria) gateway. The gateway may be a separate computer (as shown in FIG. 2) or it may be a physical or logical subsystem of the client computer itself. In box 208 the Gateway forwards command to GDS on mainframe via modem and the GDS Net. In box 210 the GDS responds to client computer (typically via the gateway) with inventory available which is displayed in the GDS display window. In box 212 the travel agent requests pricing information using GDS command line format. In box 214, the request is sent to GDS; GDS responds with inventory pricing information which is displayed in GDS display window of Cfares (or Excambria) client program in client computer. In box 216, the travel agent decides whether to select a GDS offered itinerary. If not, the GDS based part of the method ends in box 218. Otherwise, in box 230, the GDS itinerary is selected and a confirmation message received and displayed by old GDS based procedures. In box 232 paperwork is printed and account records entered as for old GDS systems.

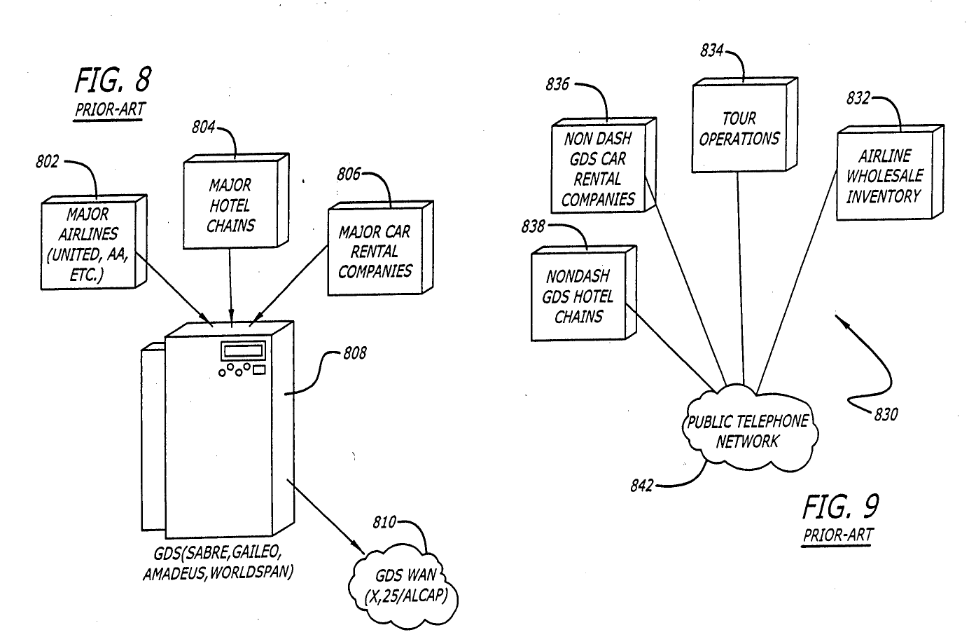

Meanwhile, in box 240, the router forwards a command to Cfares (or Excambria) web server via router and Internet. In Box 242, the Cfares (or Excambria) Web server runs filters and sends translated requests to suppliers' web sites via the Internet. In box 244, the suppliers' web sites respond to the Cfares (or Excambria) Web server. Then, in box 246, the Cfares (or Excambria) Web server formats responses of inventory and pricing information and sends them to client computer via the Internet. In box 248, the Cfares (or Excambria) client program in the client computer displays inventory and pricing information obtained via the Internet. Then in box 250, the travel agent decides whether to select an Internet offered itinerary. If not, then the web based part of the method ends in box 218. Otherwise, in box 252, a reservation request is sent to Cfares (or Excambria) Web server and, in box 254, accounting and ticketing may take place as described below in connection with FIG. 7.

It will be appreciated that, as may be required, the Cfares (or Excambria) Web server may translate commands into various forms as may be responded to by the web site of travel service suppliers such as airlines, consolidators, tours operators or the like. Thus, the Cfares (or Excambria) server maintains a dialog with various travel sites by sending web formatted commands according to the temporal needs of the many client computers at various locations. In the example given, a request for travel information between Los Angeles and San Francisco would not generate a web site inquiry to the website of British airways since they do not offer US domestic travel. On the other hand, inquiries may be sent to the web sites of the dozen or so airlines that do offer LAX-SFO ticketing. If the agent is dissatisfied with all the itineraries offered, or if indeed there are not offers for reason of no availability, the agent may terminate the procedure and start again with, for example, a revised travel date after possible consultation with the prospective traveler.

In addition to the functions described in connection with FIG. 6, embodiments of the invention may provide for capturing accounting data for travel services booked via the Cfares (or Excambria) Web server. One expanded example of the functions of box 254 according to one embodiment of the invention is shown in FIG. 7. FIG. 7 shows a flow diagram of accounting functions according to an embodiment of the invention. In box 702, the method starts. In box 704, the Cfares (or Excambria) Web server sends a reservation confirmation to a supplier web server via the Internet. In box 706, the supplier confirms the reservation. In box 708, the Cfares (or Excambria) Web server sends a reservation confirmation web page to the Cfares (or Excambria) client program in the client computer. In box 710 the Cfares (or Excambria) client application program stores the confirmation page as a reservation record into an Cfares (or Excambria) database via the Cfares (or Excambria) Gateway. In box 712 a decision is made as to whether GDS based accounting is to be used. If so, in box 714, the Cfares (or Excambria) Gateway picks up a reservation record from Cfares (or Excambria) client database and reformats it according to specific GDS. Then in box 716, the Cfares (or Excambria) Gateway sends a command to GDS to issue ticket, invoice and/or itinerary to the travel agency accounting system. In box 718, the travel agency accounting application receives the reservation record from the GDS and processes it and the method ends in box 720.

If GDS based accounting is not to be used, then in box 730 the Cfares (or Excambria) Gateway picks up the reservation record from the Cfares (or Excambria) client database and reformats it according to the travel agency's accounting application. In box 732, the Cfares (or Excambria) Gateway sends the re-formatted reservation record to the travel agency's accounting system to issue ticket, invoice and/or itinerary. In box 734, the travel agency's accounting application receives the reservation record from the Cfares (or Excambria) Gateway and processes it and the method ends.

Many other embodiments of accounting functions are feasible within the general scope of the invention. The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those of ordinary skill in the art.

The following is the “Detailed Description of Preferred Embodiment of the Invention” in application Ser. No. 10/027,477 which is being added in this application:

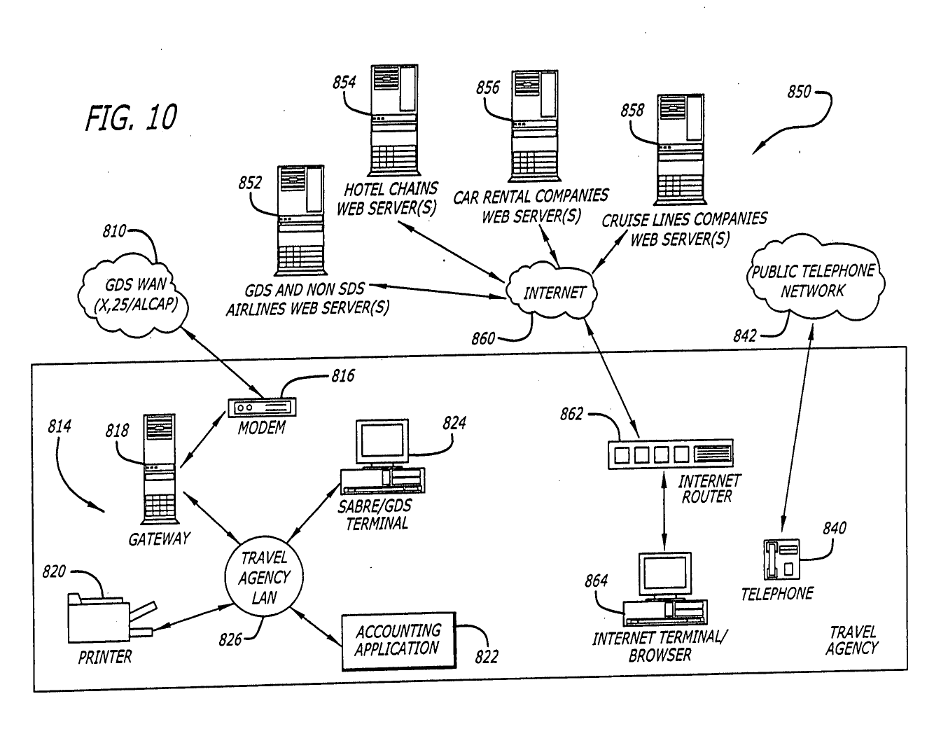

FIG. 8 is a simplified block diagram, generally indicated at 800, of a system of the prior art. The system 800 provides established and published information relating to fares from a number of major airlines 802 (e.g. American, United and Delta) relating to airplane flights and fares. It also includes room availability and room rates from a number of major hotel chains 804 and it further includes information relating to car availability and car rental rates from a number of the major car rental companies 806. It will be appreciated that other travel-related services such as boat trips may also be included.

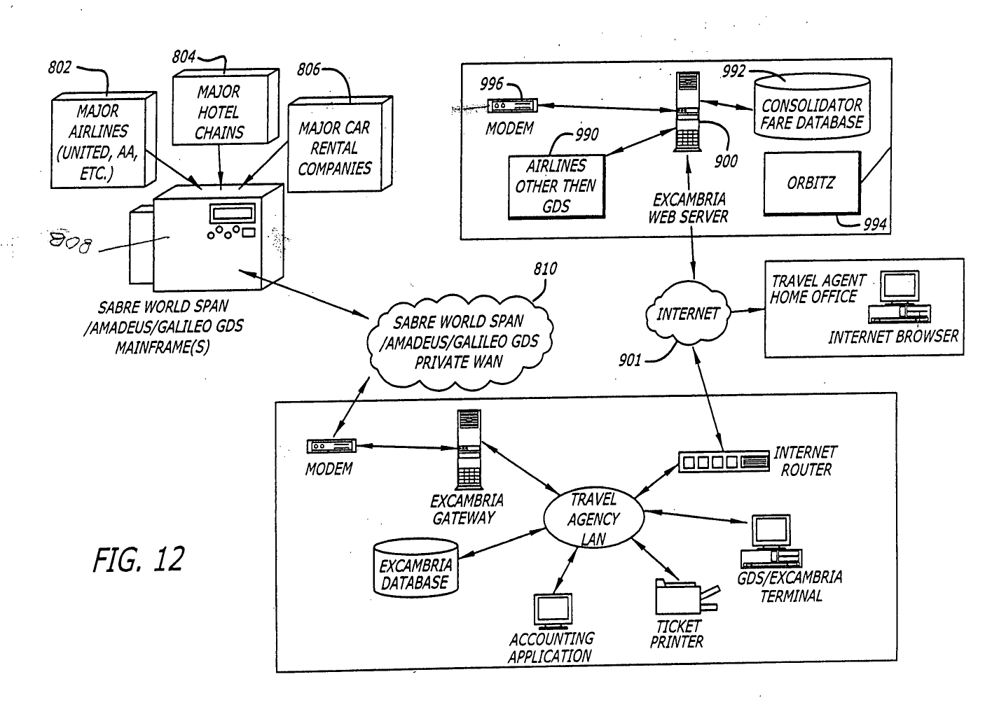

The information from the major airlines 802, the major hotel chains 804 and the major care rental companies 806 are introduced to a global distribution system (GDS) 808 which may be a legacy server. Global distribution systems now in use include Sabre, Galileo, Amadeus and Worldspan. The information from the global distribution system 808 is provided through a wide area network 810 to processing stations such as travel agencies (including a travel agency). The travel agency includes a number of substantially identical processing stations, one of which is generally indicated at 814 in FIG. 10.

The processing station 814 in FIG. 10 includes a modem 816, a gateway 818, a printer 820, an accounting application 822, a global distribution system display (illustratively Sabre) display terminal 824 and a local area network (LAN) 826. The modem 816 receives information from, and provides information to, the legacy server 808 (FIG. 8) through the wide area network 810. The modem 816 provides information to, and receives information from, the gateway 818, which may be a server. The gateway 818, the printer 820, the accounting application 822 and the display terminal 824 provide information to, and receive information from, the travel agency local area network 826.

The airlines 802 (FIG. 8) introduce established and published flight and fare information to the legacy server 808 which stores this information. In like manner, the hotel chains introduce established and published information relating to room availability and room rates to the legacy server 808, and the car rental agencies 806 introduce information relating to car availability and car rates to the legacy server 808. The legacy server 808 stores this information. Whenever requested by the travel agency, the legacy server 808 transmits the requested information to the modem 816 (FIG. 10) in the travel agency processing station 814 through the wide area network 810.

The modem 816 at the processing station 814 introduces the requested information to the gateway 818, which may be a server. The gateway 818 then introduces this information to the local area network 826 which then introduces the information to the appropriate one of the printer 820, the accounting application 822, and the display terminal 824. The printer 820 provides a record of a flight transaction, including the flight number and the flight fare, selected by the agent at the processing station 814. The accounting application 822 provides an accounting at the processing station 814 of the flight transaction selected by the agent. The terminal 824 provides a visual indication on a display screen of information relating to the different flights requested by the agent through the wide area network 810 from the legacy server 808.

It will be appreciated that the discussion above relating to flight information and flight fares applies equally as well to information relating to room availability and room rates when the agent at the processing station 814 requests this information from the legacy server 818 through the wide area network 810. It also applies equally as well to information relating to car availability and car rates when the agent at the processing station 814 requests this information from the legacy server 808 through the wide area network 810.

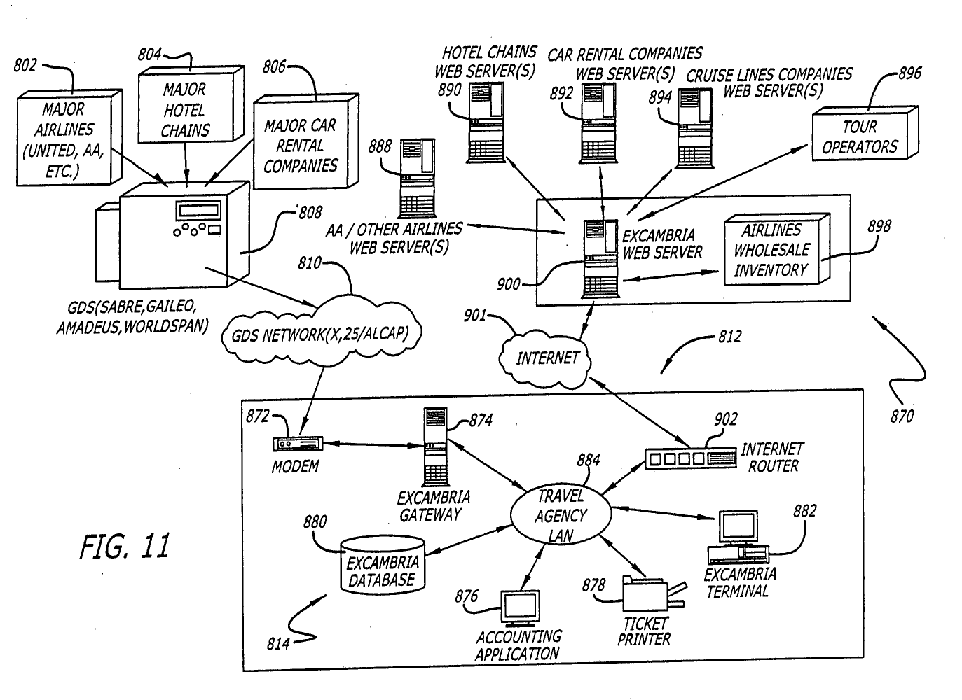

FIG. 9 shows another embodiment, generally indicated at 830, in the prior art. The embodiment 830 includes airline wholesale inventory 832, tour operators 834, non-GDS car rental companies 836 and non-GDS hotel chains 838. The airline wholesale and retail inventory is not included in the global distribution system (GDS) 808 shown in FIG. 8. It includes airline fares discounted from the established and published fares. The non-GDS hotel chains 838 are those other than the global distribution system hotel chains included in the server 808. The tour operators 834 sponsor tours to different parts of the world and include such operators as Tauck.

The travel agency in FIG. 10 obtains information from individual ones of the different inventory sources 832, 834, 836 and 838 in FIG. 9 by instituting a call from a telephone 840 at the travel station. This call passes through a public telephone network 842 in FIG. 10 to one of the sources 832, 834, 836 and 838 in FIG. 9. As will be appreciated, this mode of obtaining information is slow. It is also limited in its capabilities because the lines in the telephone network may be busy. Time is also required to connect the travel agent to the proper provider of information at the telephoned one of the sources 822, 834, 836 and 838. This is particularly true in the telephone systems at the sources where computerized machines, and not humans, answer the phone.

FIG. 10 shows an embodiment, generally indicated at 850, of applicants' invention of the prior art. The embodiment shown in FIG. 10 is disclosed and claimed in application Ser. No. 10/027,477 which is assigned of record to the assignee of record of this application. Although this embodiment is shown in FIG. 10, it is claimed in a separate application filed by applicants. The embodiment 850 may include web servers 852 of the global distribution system and other airlines not in the global distribution system, web servers 854 of hotel chains, web servers 856 of car rental companies and web servers 858 of cruise line companies. These companies are only illustrative, since web servers from other operational companies may also be included without departing from the scope of the prior art system shown in FIG. 10. Information from the web servers 852, 854, 856 and 858 is passed through the internet 860 to an internet router 862 in the travel agency in FIG. 10. The indications from the router 860 pass to an internet display terminal 864 which may include a browser.

As will be seen, requests for information are provided from the travel agency 814 through the internet 860 to the sources 852, 854, 856, and 858. Responses to the requests are made through the internet by the sources 852, 854, 856, and 858. These responses cause information to be displayed on the display terminal 864. Communication between the travel agency 814 and the sources 852, 854, 856, and 858 offer certain advantages. One advantage is that the establishment of the communications between the web servers 852, 854, 856, and 858 and the display terminal 864 is provided in a minimal time. Another advantage is that any possibilities of busy lines as in telephone calls are minimized. A further advantage is that the cost to the operators of the web servers is minimized.

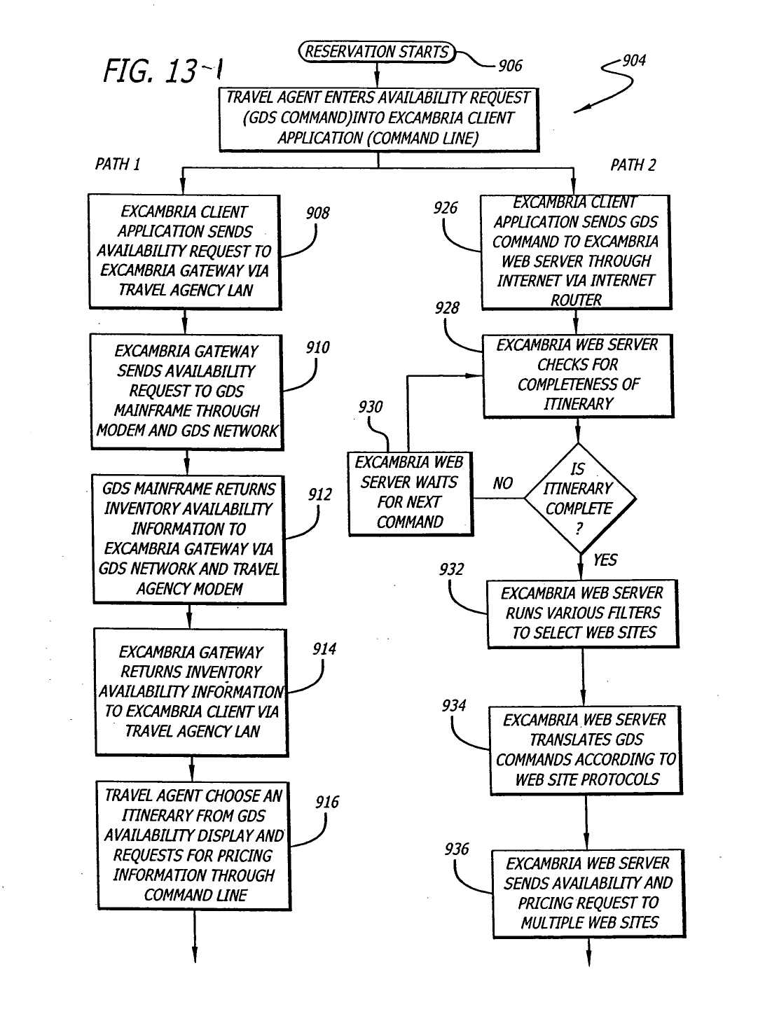

FIG. 11 shows a preferred embodiment of a system, generally indicated at 870, included in the prior art and disclosed in application Ser. No. 10/027,477. The system 870 includes the system 800 of the prior art as shown in FIG. 8. Thus, the stages 802, 804, 806, 808, and the wide area network 810 are the same as shown in FIG. 9. However, a modem 872, a gateway 876, an accounting application 876 and a printer 878 are different from corresponding members shown in FIG. 9 even though they have the same designations as the members shown in FIG. 9. The difference in the gateway 874 is indicated in FIG. 11 by the designation of the gateway as a Cfares (or Excambria) gateway. A Cfares (or Excambria) database 880 and a Cfares (or Excambria) display terminal 882 are new in FIG. 11. Although a travel agency local area network 884 in FIG. 11 has the same designation as the network 826 in FIG. 9, it is different from the network 826 in FIG. 9. The differences between correspondingly designated stages in FIGS. 9 and 11 will be explained in detail subsequently. The travel agency local area network 884 is in two (2)-way communication with each of the Cfares (or Excambria) gateway 874, the Cfares (or Excambria) database 880, the accounting application 876, the ticket printer 878 and the Cfares (or Excambria) display terminal 882.

FIG. 11 also includes an arrangement similar to that shown in FIG. 10 and discussed above and included in the prior art and disclosed in co-pending application Ser. No. 10/027,477. FIG. 11 includes a web server 888 for airline flight and fare information. The web server may provide flight and fare information for other airlines (e.g. Southwest Airlines) than those providing information in the legacy server 808. FIG. 11 also shows a web server 890 for other hotel chains than those providing information in the web server 804. In like manner, FIG. 11 includes a web server 892 for other car rental companies than those provided in the web server 806 for the major car rental companies.

FIG. 11 also includes web servers other than those specified in the previous paragraph. For example, a web server 894 provides information relating to cruises (e.g. cities visited, dates and other amenities) and fares offered by major cruise line companies. A web server 896 is also included in FIG. 11 for providing information relating to tour companies (e.g. Tauck Tours). A web server 898 in FIG. 11 also provides airline flight and fare information from the wholesale inventory of these airlines. It will be appreciated that the web servers capable of being used are not limited to those shown in FIG. 11. It will also be appreciated that other web servers than some of those listed in FIG. 11 can be used.

A two (2)-way communication is provided between each of the servers 888, 890, 892, 894, 896 and 898 to a Cfares (or Excambria) web server 900. The server 900 is called a Cfares (or Excambria) server because it processes information not processed by any other server. For example, a web server corresponding to the Cfares (or Excambria) web server 900 is not known to exist in the prior art that processes information from all of the servers 880-898 (even numbers only). The information from the Cfares (or Excambria) server 900 is introduced to an internet router 901 in the processing station 814 at the travel agency 812. A two (2)-way communication is provided between the internet router 902 and the travel agency local area network 884.

The operation of the web servers 802-808 (even numbers only) in FIG. 11 in providing information through the wide area network 810 to the processing station 814 in the travel agency and in receiving information through the internet from the web server 808 was discussed previously in connection with FIG. 8. The operation of the web servers 888, 890, 892 and 896 in providing information to the travel agency 814 through public telephone lines 842 has been discussed in detail previously in connection with FIG. 9. However, in FIG. 10, the information from the web servers 888, 890, 892 and 896 is provided to a Cfares (or Excambria) web server 900. It is designated as a Cfares (or Excambria) web server because it receives information from other sources than is provided to the public telephone lines 842 in FIG. 9 and because there is no web server in FIG. 9.

FIG. 11 shows that information is introduced to the Cfares (or Excambria) web server 900 from the web server 888. The web server 888 provides flight and fare information from other airlines than those represented in the legacy web server 808. For example, Southwest Airlines is a good example of this. The Cfares (or Excambria) web server 900 also receives information from the web server 894, which provides information from cruise line companies (e.g. Carnival) for various types of cruises such as ocean cruises.

The information from the legacy web server 808 passes through the wide area network 810, the modem 872 and the Cfares (or Excambria) gateway 874 to the local area network 884 at the travel agency 814. The information from the Cfares (or Excambria) web server 900 passes through the internet router 902 to the local area network 884 at the travel agency 812. The Cfares (or Excambria) database 880 receives the information from the travel agency local area network 884.

The information passing to the Cfares (or Excambria) database 880 from the legacy server 808 may have a different protocol than the information passing to the database from the Cfares (or Excambria) web server 900. The Cfares (or Excambria) database 880 converts the non-compatible protocol information from the web servers 808 and 900 into a compatible protocol. This information then passes through the local area network 884 to the Cfares (or Excambria) display terminal or display screen 882. The Cfares (or Excambria) display terminal 882 is constructed in a manner similar to that shown in FIG. 5 and described above.

The information from the legacy server 808 is displayed in the portion 501 of the display terminal 882 in FIG. 5 and the information from the Cfares (or Excambria) web server 900 is displayed in the portion 502 of the display terminal 882 in FIG. 5. A portion 504 of the display terminal 500 in FIG. 5 may indicate the particular flight which the travel agent is investigating at any particular time. For example, the portion 504 of the display terminal 500 in FIG. 5 may indicate that the travel agent is investigating the particulars of a flight 222 on American Airlines from Los Angeles to Boston on Jan. 24, 2002.

The simultaneous display on the display terminal 882 in FIG. 11 of information from the legacy server 808 and Cfares (or Excambria) web server 900 offers certain advantages. It allows the travel agent at the travel agency to see the information from all of the available sources at the same time. For example, it allows the travel agent to view the flight and fare information relating to travel on a particular date between two specified locations from the major airlines at their established and published fares and from the other airlines at their established and published fares and also to see discounted fares from the airlines and wholesale fares from the airlines, all for flights on a specified day between a specified originating location and a specified destination. This allows the travel agent and the client to make a decision based upon all available facts, all of which are made available to the agent at the same time.

When the travel agent and the client select a particular airline flight, the Cfares (or Excambria) database 880 provides this information to local area network 884. The local area network 884 then transmits this information to the ticket printer 878 at the travel agency 814 or to the legacy server 808 to have a ticket printed. This choice may be made by the processing station 814 at the travel agency. When the ticket is to be printed at the local travel agency 814, the transmission of the request to have the ticket printed at the travel agency is made from the Cfares (or Excambria) database 880 through the local area network 884 to the ticket printer 878. When the ticket is to be printed at the legacy server 808, the request to have the ticket printed is made from the Cfares (or Excambria) database 880 through the local area network 884, the Cfares (or Excambria) gateway 874 and the modem 872 to the legacy server 808.

In addition to the advantages discussed above, the system in FIG. 11 provides other advantages, particularly to the travel agent at the travel agency. As previously indicated, the airlines, particularly the major airlines listed in the legacy server 808, have been reducing the commissions paid to travel agents for generating tickets for flights on these airlines. The system in FIG. 11 provides the travel agents an opportunity to obtain discounted fares from the airlines and to charge a commission on these discounted fares when the travel agent quotes the discounted fares to the client. The travel agent can do this by quoting to the client a single price which includes the discounted fare and the commission. The client profits from this discounted fare (even with the commission added) because the client does not have to pay the established and published fare of the airlines. There is another advantage in the system of FIG. 11 to the travel agent. This results from the fact that the travel agent can obtain information from all of the available sources in a minimal amount of time and can have all of this information posted on the display terminal 882 at the same time. This facilitates the selection by the agent of the best flight arrangement for the client in a minimal period of time, this decision being based upon all of the available facts. The system is also advantageous to the airlines because it allows the airlines to significantly reduce their cost, particularly their selling and marketing expenses. The system is further advantageous to the efficient airlines because their fares will be below those of the inefficient airlines and this will be readily apparent on the split screen 500 in FIG. 5.

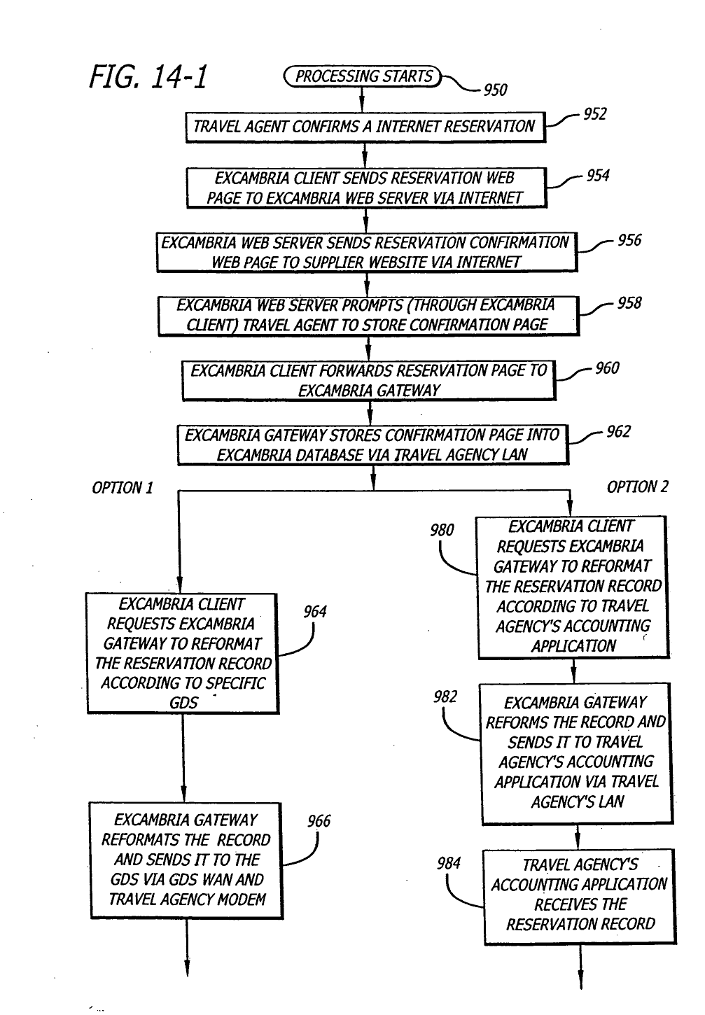

FIGS. 13-1 and 13-2 constitute a flow chart, generally indicated at 904, showing the successive steps involved in operating the system shown in FIG. 11 and described above. As a first step (906), the system is activated. The travel agent at the travel agency then sends (908) an availability request through the local area network 884 (FIG. 11) and the Cfares (or Excambria) gateway 874 to the legacy web server 808 as indicated at 910. The global distribution system then returns (912) the inventory availability information to the Cfares (or Excambria) gateway 874 through the wide area network 810 and the modem 872. In other words, the Cfares (or Excambria) web server 808 indicates to the Cfares (or Excambria) gateway 874 whether seats are available on a specified flight and, if so, what the prices of the seats are. The Cfares (or Excambria) gateway 874 indicates this seat availability, and the prices of the available seats, through the local area network 884 to the Cfares (or Excambria) terminal 882. This is indicated at 914 in FIG. 13.

At 916, the travel agent selects an itinerary available from the global distribution system in the legacy server 808 and requests pricing information relating to the itinerary. The travel agency sends, as indicated at 918 and 920 in FIG. 13-2, a pricing request for the selected flight to the legacy server 808 through the travel agency local area network 884, the Cfares (or Excambria) gateway 874, the modem 872 and the wide area network 810. The legacy server 808 then sends the requested information to the display terminal 882 at the processing station 814 in the travel agency through the wide area network 810, the modem 872 and the local area network 884, as indicated at 922 and 924 in FIG. 13-2.

The travel agent at the travel agency may also send requests for information through the local area network 884, the router 902 and the internet 901 to the Cfares (or Excambria) web server 900. This is indicated at 926 in FIG. 13-1. The Cfares (or Excambria) web server 900 checks (928) for the completeness of the itinerary transmitted to it from the local area network 884. If the itinerary is not complete, the Cfares (or Excambria) web server 900 waits for the next command from the local area network 884. See 930 in FIG. 13-1. If the itinerary is complete, the Cfares (or Excambria) web server 900 activates (932) various filters to select web sites in the Cfares (or Excambria) server. This is indicated at 932 in FIG. 13-1. The Cfares (or Excambria) web server 900 then translates (934) the global distribution system commands from the web server according to the protocols in the selected web sites.

The Cfares (or Excambria) web server 900 then sends (936) the flight availability and pricing requests to multiple websites in the Cfares (or Excambria) server and receives (938) in FIG. 13-2 the flight availability and pricing information from the multiple web sites. The Cfares (or Excambria) web server 900 aggregates (940) the flight availability and pricing information from the multiple web sites. As indicated at 942, the Cfares (or Excambria) web server 900 thereafter submits the flight availability and pricing information to the Cfares (or Excambria) database 880 at the processing station 814 in the travel agency. The travel agent then selects a flight itinerary, and a pricing information for that itinerary, from the global distribution system information in the legacy server 808 and the individual flight in the Cfares (or Excambria) web server 900. The reservation of the selected flight itinerary and fare is now complete. See 946 in FIG. 13-2.

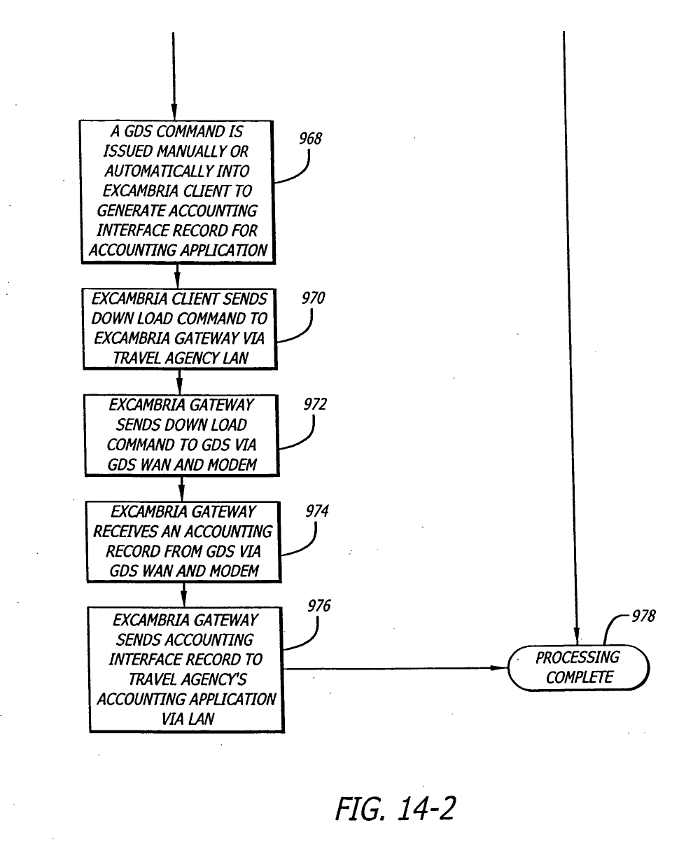

FIGS. 14-1 and 14-2 constitute a flow chart indicating the steps in providing an accounting after the flight itinerary and price have been selected on the basis of the information in the Cfares (or Excambria) database 880 in FIG. 14-1. The processing of the accounting commences at 950 in FIG. 14-1. The travel agent confirms a ticket reservation, as at 952, on the internet 901 or in the global distribution system network 810. See 954 in FIG. 14-1. The travel agency then sends (954) the reservation web page to the Cfares (or Excambria) web server 900 via the internet 901. The Cfares (or Excambria) web server 900 thereafter sends (956) the reservation confirmation web page to the web site at the travel agency through the internet 901 and prompts (958) the travel agency to store the confirmation page. The travel agency subsequently forwards the reservation page to the Cfares (or Excambria) gateway 874 at the travel agency. See 960 in FIG. 14-1. The Cfares (or Excambria) gateway 874 thereafter stores the flight confirmation page in the Cfares (or Excambria) database 880 at the travel agency in FIG. 11 as indicated at 962 in FIG. 14.

There are then two (2) options. One option is indicated in the sequence of blocks at the left end below the block 962. The other option is indicated in the sequence of blocks at the right and below the block 962 in FIG. 14-1. In option one (1) at the left end below the block 962, the travel agent requests through the Cfares (or Excambria) database 880 the legacy server 808 in FIG. 11 to reformat the reservation on record in accordance with the global reservation system protocol. This is indicated at 964 in FIG. 14-2. The Cfares (or Excambria) gateway 874 reformats the reservation record and sends it to the legacy server 808 via the modem 872 and the wide area network 810. See 966 in FIG. 14. A global distribution system command is then issued (968) manually or automatically at the travel agency to generate an accounting interface record for the accounting 876 in FIG. 11.

The processing station at the travel agency thereafter sends a load command to the legacy server 808 through the modem 872 and the wide area network 810. This is indicated at 972. After that, the Cfares (or Excambria) gateway 874 receives an accounting record from the legacy server 804 through the wide area network 810 and the modem 872. See 974 in FIG. 14. The Cfares (or Excambria) gateway then sends the accounting interface record to the accounting application 876 through the local area network 884 in FIG. 11. The accounting application makes a recording of such information as the client, the ticket sold to the client, and the price of the ticket. The process is now complete. See 978 in FIG. 14.

In option two (2), after the storage of the confirmation page in the Cfares (or Excambria) database 880 (see 962), the travel agency requests (980) the Cfares (or Excambria) gateway 874 to reformat the reservation record according to the accounting application 876. (See 982 in FIG. 14-1.) The Cfares (or Excambria) gateway 874 then provides this reformatting and sends it to the accounting application 876 through the local area network 884. See 982 in FIG. 14-1. The accounting application 876 receives and records the reservation information as at 984. The processing of the accounting record in now complete (978).

The ticketing of the selected flight by the travel agent for the client may have a flow chart substantially identical to the flow chart shown in FIGS. 14-1 and 14-2. However, instead of specifying the accounting application as in FIGS. 14-1 and 14-2, the flow for the ticket printer would substitute the word “printer” for the words “accounting applications”. In this way, the ticket can be printed either at the legacy server 808 (option 1) or the ticket can be printed at the ticker printer 878 (option 2).

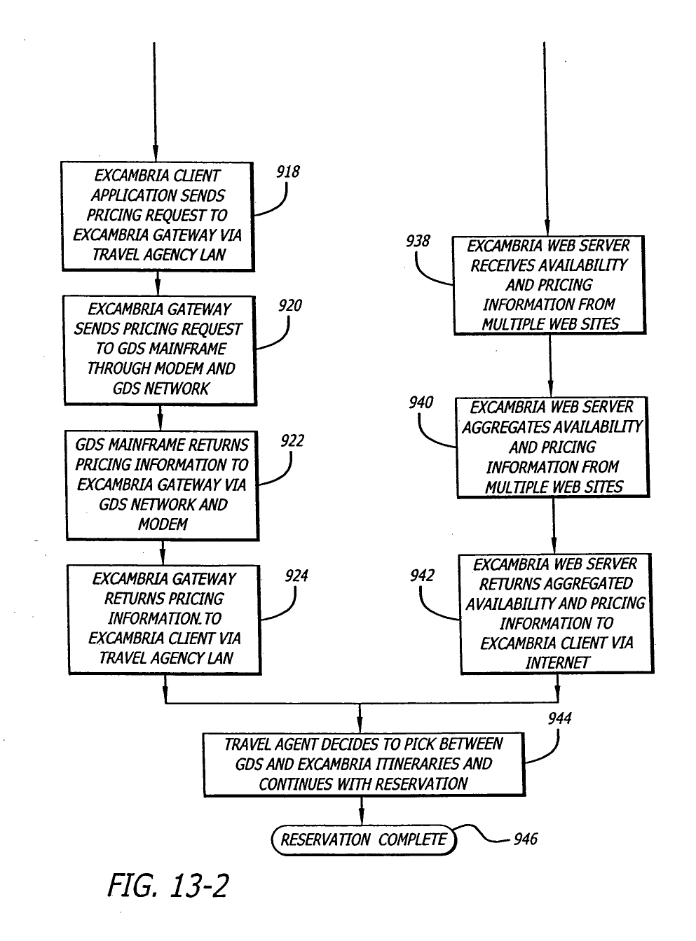

FIG. 12 is similar to FIG. 11. However, in place of the six (6) web servers feeding information into the Cfares (or Excambria) web server 900 as shown in FIG. 11, three (3) other web servers feed information into, and receive information from, the Cfares (or Excambria) web server 900. These are (a) a web server 990 providing information relating to airlines (e.g. Southwest Airlines) other than the primary airlines (e.g. American, United and Delta) in the legacy web server 808, (b) a web server 992 providing a database for consolidators (companies which purchase blocks of tickets from the airlines at discounted prices and offer these tickets to the public at prices above the discounted prices but below the established and published prices and (c) a web server 994 for Orbitz. Information in the Orbitz web servers 994 relates to last minute reductions in price by the airlines for flights which will be somewhat empty if the prices of the flights are not steeply discounted. The information from the web servers 990, 992 and 994 are introduced through the internet 901 to the travel agency and information from the travel agency is introduced through the internet to the web servers 990, 992 and 994.

It will be appreciated that the web servers 990, 992 and 994 are shown in FIG. 12 separately from the web servers 888-898 (even numbers only) in FIG. 11 only for purposes of convenience. The web servers associated with the Cfares (or Excambria) web server 900 in FIGS. 11 and 12 may constitute any one of any combination of the web servers shown in FIGS. 11 and 13. Furthermore, the use of the system shown in FIGS. 11 and 12 is not limited to the web servers shown in FIGS. 11 and 12. This will be obvious to a person of ordinary skill in the art.

A modem 996 is shown in FIG. 12 for providing a two (2)-way communication between the Cfares (or Excambria) web server 900 and the legacy server 808. This two (2)-way communication is provided through the wide area network 810 between the modem 996 and the legacy server 808.

As previously discussed, travel-related services are ephemeral. This applies not only to airplane fares but also to boat fares, rental cars and hotel room rates. The services are ephemeral because the opportunity to obtain income from the travel-related services expires when the services can no longer be used. In other words, the opportunity to obtain income from an unoccupied seat in an airplane expires when the airplane takes off from its place of departure to a destination airport. Similarly, the opportunity to obtain income from an unoccupied hotel room on a particular night expires when the particular night has passed.

Suppliers of travel-related services appreciate that their services are ephemeral. Because of this, the supplier of travel-related services appreciate that it would be better to obtain a reduced income from expiring services than not to obtain any income at all. In other words, suppliers of travel-related services appreciate that, for a service normally having a price of $100, it would be better to receive a price of $75 and even $50, for the service as the services expire rather than not to receive any income at all from the service.

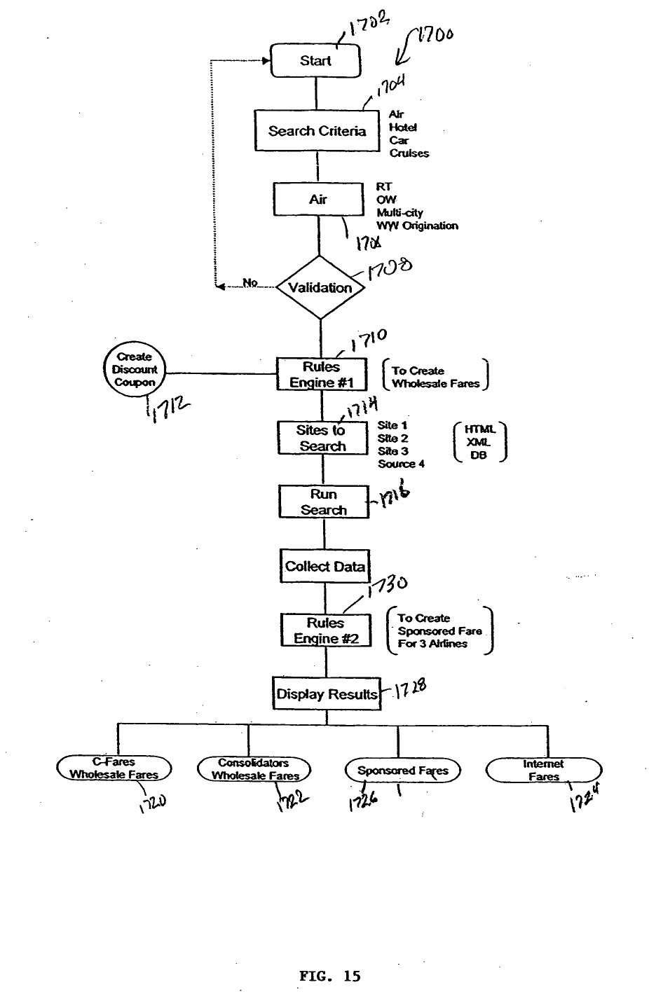

FIG. 15 is a flow chart generally indicated at 1700, showing the operation of a system for, and method of, adjusting the price of an airline ticket to meet, and even beat, the competition and for providing ticket upgrades which are in place of, or in addition to, price reductions. The start of the flow chart is indicated at 1702. Search criteria are provided at 1704. The search criteria may distinguish between different travel-related services or criteria such as airlines, hotels, car rentals and boat cruises. When airlines are chosen as the travel-related services as indicated at 1706, the type of airline travel may be defined. For example, the airplane travel may constitute a round-trip (RT), one-way flight (OW), a travel involving a multiple of destinations (multi-city) and a world-wide travel (WW origination). When all of these services or criteria are determined, they are checked as at 1708 to provide validation. If validation cannot be provided, a return is made to the start position 1702 to redefine the travel-related searches or criteria.

If validation is provided, the flow chart proceeds (1710) to a block designated as “Rules Engine #1.” This may be defined by the following example. The passenger is interested in obtaining a round-trip coach ticket between Los Angeles and New York on Mar. 14, 2005 at about 11 a.m. Both United and American offer flights at this time or within a time period between 9 a.m. and 1 p.m. on Mar. 14, 2005. The published prices of United and American for around the ticket are the same—$540. Both flights provide travel between Los Angeles and New York as specified by passenger P. Two (2) days before the flight, United's plane is substantially full but America's plane is half empty. American does not know that United's plane is substantially full and United does not know that American's plane is half empty.

American notifies the travel agent T that the travel agent is to discount the price of the flight so that the price for the American ticket is below the published price for the United flight. This price is conveyed to the travel agent on a confidential basis so that United is not aware that American will be reducing the price of the ticket. The price reduction may be on a percentage basis (a reduction illustratively of twenty percent (20%)) so that American's price is reduced by $108 to $432. Alternatively, the discount may be on a fixed price basis. For example, the price of the tickets may be reduced by $108 so that the price is $432. It will be appreciated that the percentage reduction may reduce the price of the ticket to a different value than the fixed price reduction. It will also be appreciated that the originally quoted prices of the United and American tickets may not be the same. For example, the originally quoted price of the American ticket may be higher than the originally quoted price of the United ticket.

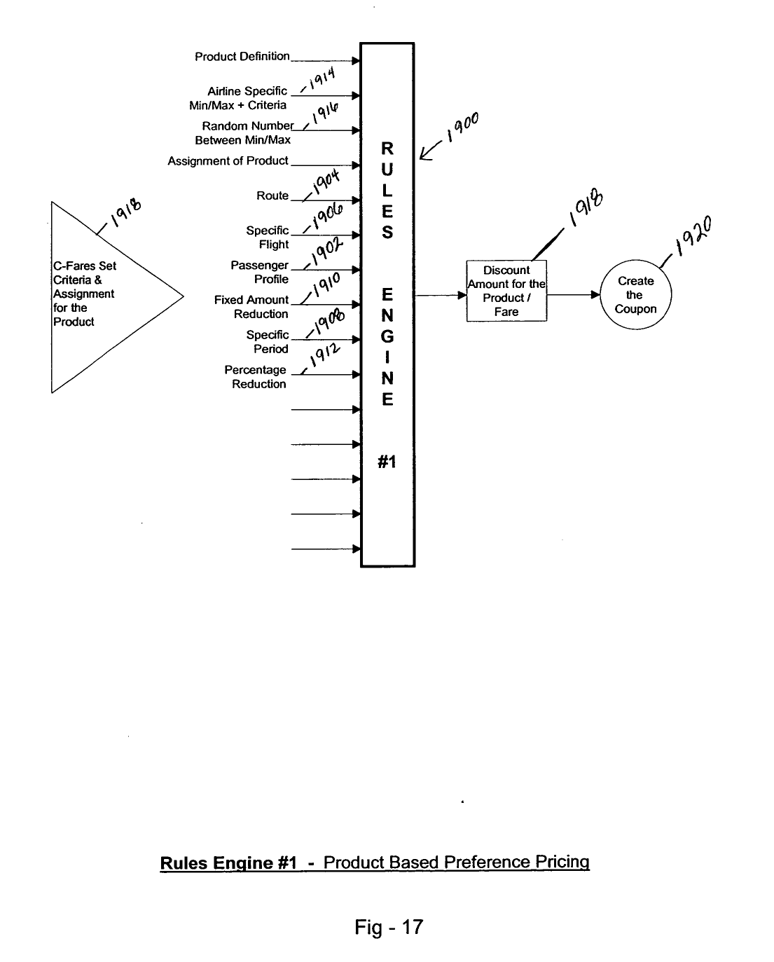

The price reduction provided by American is known to the travel agent T who works for a travel agency and not for American. The price reduction is not known to agents who work for American and write airline tickets for American. Because of this, if the travel agent attempted to write a ticket with the reduced price, the travel agents at American would refuse to confirm that ticket because the price for the reduced ticket would be strange to them. To eliminate this problem, the ticket agent writes the ticket at American's standard price of $540 and issues a redeemable chit, certificate or discount coupon to the passenger for the price of the reduction. This chit, certificate or discount coupon is redeemable by the passenger at the offices of American in any business—acceptable method such as in person or by mail. The creation of the redeemable discount coupon is indicated at 1712 in FIG. 17.

Different sites are searched (1714 and 1716) to obtain indications from these sites of individual flights which meet the criteria established by the passenger P. They are designated as site 1, site 2, site 3 and source 4. They are obtained by well-known protocols such as HTTP:/WWW, VML and Db (Direct access of fare data bases). They can be classified as being obtained from the wide area network (wan) and the internet has been described in detail above. As a result of the search, data is collected (1718) of the acceptable flights from the different airlines. The collected data is respectively indicated at published fares, wholesale fares 1720, consolidators' wholesale fares 1722 and internet fares 1724. These fares have been discussed above. Sponsored fares are also produced. These are the fares that have been reduced in price as discussed above. The fares 1720, 1722, 1724 and 1726 are displayed (1728) on a screen such as the server 500 shown in FIG. 5.

The price discount to the passenger P may be indicated in either of two (2) different and alternative ways. In one (1) way, the travel agent T does not show the original and published price of the ticket for the passenger P's round-trip between Los Angeles and New York. The travel agent T shows only the reduced price of $432. Because of this, the passenger P is not aware that American has reduced the price of the ticket by $108. In the other way, the travel agent displays the original and published fare of $540 and subsequently shows that the fare has been reduced to $432. American would probably prefer to use the first approach because American would prefer not to have the passenger know that the passenger car obtain reduced prices by making last minute deals with American.

FIG. 15 also includes a box 1730 designated as Rules Engine #2. Rules Engine #2 involves an upgrading of the passenger P's flight ticket. Examples of upgrading are a change of the passenger P's ticket from coach class to business class or first class. Another example is the grant of frequent flyer miles to passenger P. The upgrading of the passenger P does not require any additional payment by the passenger P. The upgrading of the passenger P may be in addition to the price reduction indicated by Rules Engine #1 or may be instead of any price reduction. The upgrading of the passenger P is designated as a Sponsored Fare 1726 in FIG. 15. It will be appreciated that any combination of Rule Engine #1 and Rule Engine #2 may be provided to the passenger P.

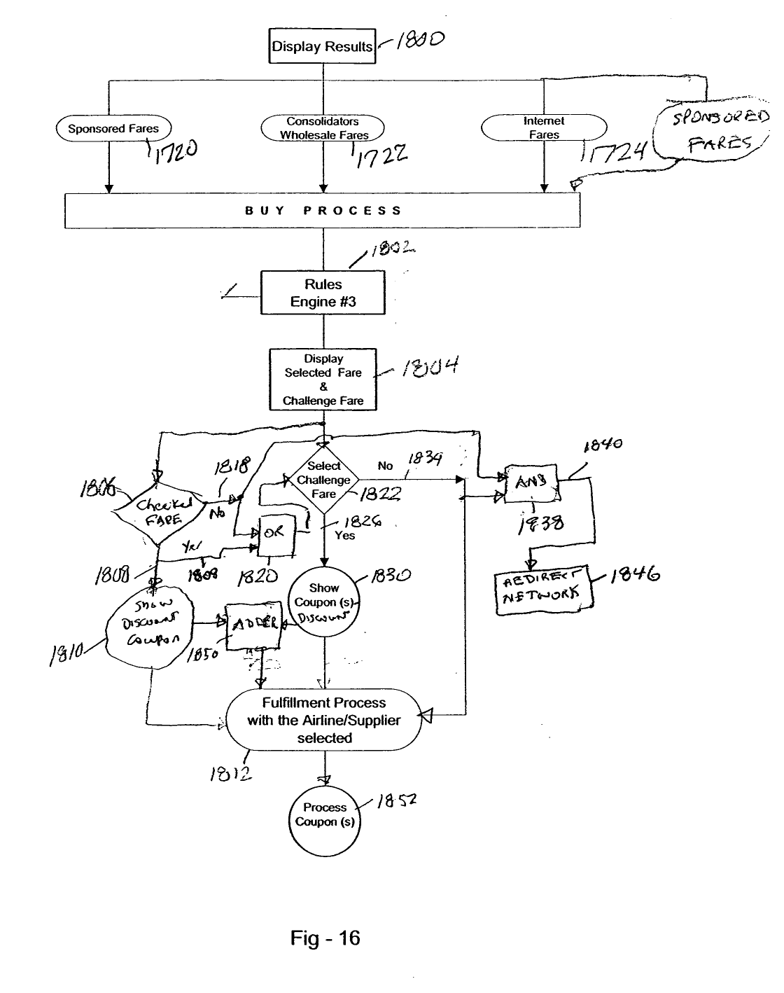

FIG. 16 is a flow chart in which a further price reduction in addition to that designated as Rules Engine #1 is provided. This further price reduction is designated in FIG. 16 as Rules Engine #3. As a first step in FIG. 16, the Cfares wholesale fares 1720, the Consolidators Wholesale Fares 1722, the internet fares 1724 and the sponsored fares (the fares involving the special price reductions) are displayed (1800) on a screen for inspection and evaluation such as shown in FIG. 5. It may be that the passenger P would still prefer to buy the round-trip ticket from United. Rules Engine #3 may then come into effect (1802).

In Rules Engine # 3, the ticket agent T offers the passenger P an additional price reduction to create a challenge fare. For example, the additional price reduction may be $50. It may constitute a second price reduction evidenced by a separate chit or certificate or discount coupon for $50 in addition to the discount coupon previously offered for $108. Alternatively, a single discount coupon may be issued for $158. In either alternative, the discount coupon(s) may be redeemed at the American offices. As shown at 1804, the checked fares (Rules Engine #1) and the challenge fares (Rules Engine #3) may be separately displayed on the display screen or, alternatively, the combination of the checked and challenge fares may be displayed on the display screen or, as a further alternative, both price reductions may be simultaneously shown on the display screen.

An indication is then provided of the price reduction(s) provided by American to the passenger P. As a first step, a determination 1806 is made of the price reduction(s) accepted by the passenger P. If the passenger P has accepted a checked fare, an indication to this effect is provided at 1808 and the discount coupon is indicated at 1810. A process is initiated as at 1812 to fulfill the redemption by American of the discount accepted by the passenger P in Rule Engine #1. If the passenger P has not accepted a checked fare, an output is produced on a line 1818. The signals or the lines 1808 and 1818 are introduced to an OR network 1820. This causes a signal to pass to a Select Challenge Fare Box 1822. When the challenge fare is selected by the passenger, an output on a line 1826 causes a discount coupon 1830 for Rules Engine #3 to be displayed. An adder 850 adds the discounts indicated in the boxes 1810 and 1830 and indicates this total in the adder 1850. If the challenge fare is not selected, an indication is provided on a line 1834. The indications from the line 1834 and the line 1818 are introduced to an AND network 1838. The resultant signal on a line 1840 passes to a box 1846 designated as Re-direct to the internet source. This initiates a reevaluation of the discounts submitted to the passenger P.

FIG. 17 provides additional information concerning Rules Engine #1. FIG. 17 includes a panel generally indicated at 1900 and designated as Rules Engine #1. The panel includes a plurality of input terminals one of which is indicated at 1902 and is designated as “Passenger Profile”. The information at the terminal 1902 may provide information identifying the passenger and distinguishing the passenger from all of the other individuals who fly on American Airlines. For example, the passenger profile may include the passenger's name, age, address, previous flights with American, passenger class in each flight, and frequent flyer miles held by the passenger.

The departure and arriving terminals (Los Angeles and New York) may be indicated at a terminal 1904 designated as “Route”. The specific flight on that Route is indicated at 1906. The specific time for the scheduled departure and arrival of the specific flight may be indicated at a terminal 1908. If the price reduction is a fixed amount in accordance with Rules Engine #1, this is indicated at a terminal 1910 in FIG. 17. On the other hand, if the price reduction is a percentage of the published fare for the flight, this is indicated at a terminal 1912 in FIG. 17. Terminal 1914 indicates specific minimum and maximum dollar amounts for the price reduction and additionally indicates the criteria used to establish the minimum and maximum values. A terminal 1916 indicates a random number between the minimum and maximum values. This is the value of the price reduction. The information is introduced to the different terminals on the panel 1900 through a web interface 1918.

The passenger P may accept American's offer to provide tickets for the flight at a price equal to United's published fare for the flight less a discount (Rules engine #1) offered by American and accepted by the passenger. This discount is not known to the travel agents employed by American. Because of this, the ticket prepared by the travel agent T indicates the published fare of $540. However, a discount of $108 is recorded in the travel agent's documentation, as indicated at 1918 in FIG. 17. A coupon is then prepared (1920) for the discount of $108 in the price paid by the passenger P. This coupon is displayed by the travel agent T to the passenger P and is redeemed by the passenger P by mail or at the American ticket counters or in any other suitable way.

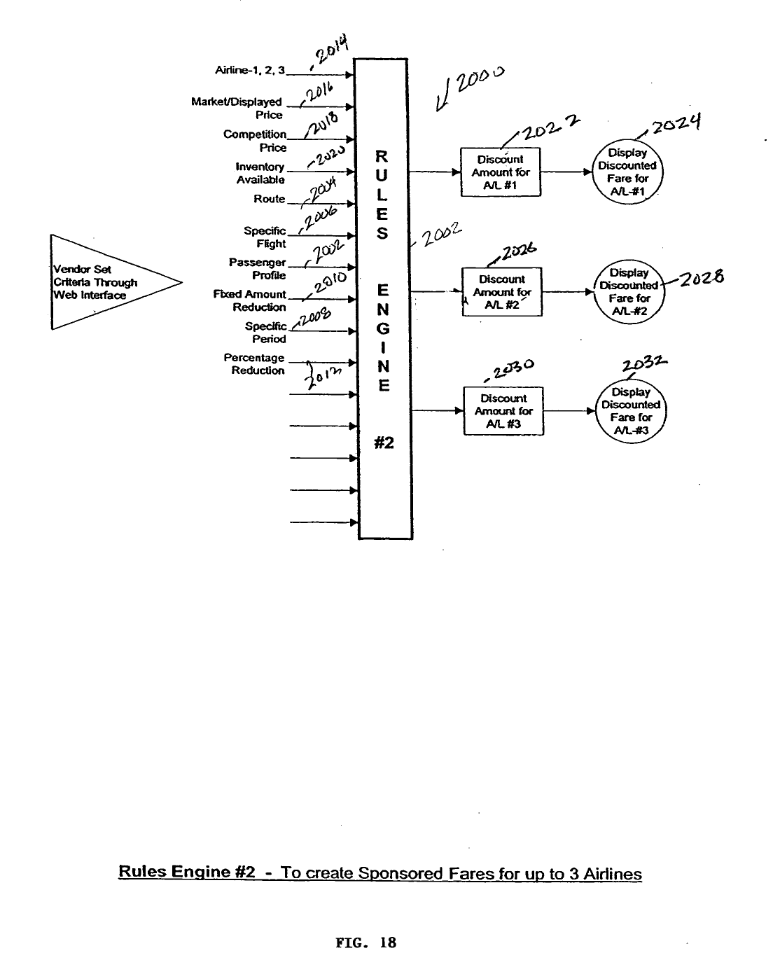

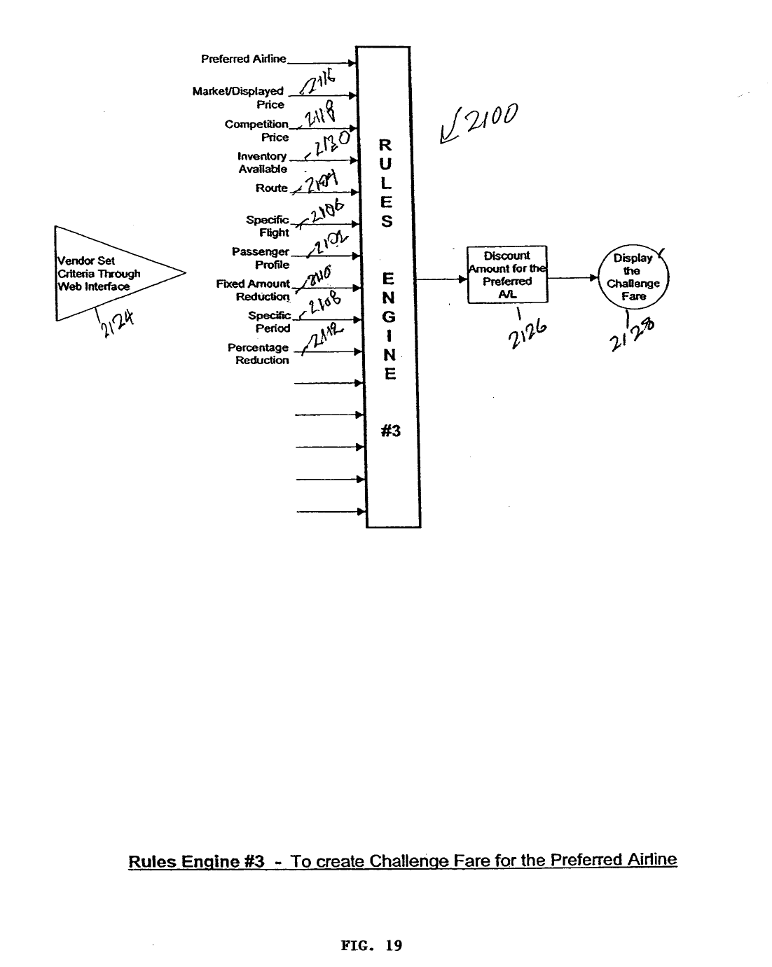

FIG. 18 provides additional information concerning Rules Engine #2. FIG. 18 includes a panel generally indicated at 2000. The panel 2000 includes a passenger profile terminal 2002, a Route terminal 2004, a specific flight terminal 2006, a specific period terminal 2008, a fixed amount reduction terminal 2010, and a percentage reduction terminal 2012 respectively corresponding to the passenger profile terminal 1902, the Route terminal 1904, the specific flight terminal 1906, the specific period terminal 1908, the fixed amount reduction terminal 1910 and the percentage reduction terminal 1912 in FIG. 19.

The panel 2000 also includes a terminal 2014 designated as “Airlines 1, 2, 3”. Airlines 1, 2, 3 may respectively be the major airlines such as American, United and Delta. A terminal 2016 displays the published prices of flights by United, Delta and Continental. These prices are designated as market Displayed Price. A terminal 2018 displays the competition price. A terminal 2020 designated as “Inventory Available” designates the number of empty seats in the American Airlines flight.

An account amount is displayed (2022) that American would have to charge in order for American to sell tickets on the American Flight. The discounted fare (including the flight discount proposed by American) is indicated at 2024. Information similar to that shown in boxes 2022 and 2024 is shown in boxes 2026 and 2020 for an American flight No. 2. and in boxes 2030 and 2032 for an American Flight #3.

It will be appreciated that the ticket agent T may represent different airlines on different flights. For example, the ticket agent T may represent American Airlines on flight #1 in FIG. 18, United Airlines in Flight #2 and Delta Airlines in Flight #3. It will also be appreciated that the flight criteria may be different for different flights. For example, one of the flight criteria for Flight #1 in FIG. 2 is that the flight has to be non-stop and the departure and arrival airports have to be the major airports (e.g., JFK airport in New York and LAX airport in Los Angeles). Flight #2 may provide for more than one (1) stop between New York and Los Angeles. Flight #3 may also provide for substituting secondary airports (e.g., LaGuardia in New York and Burbank in Los Angeles) instead of the primary airports (Kennedy Airport in New York and Los Angeles International Airport in Los Angeles).

The same principles as specified above may apply to situations where the travel-related service relates to other than airplane flights. For example, travel-related services #1 may relate to hotels in New York with four-star ratings. Travel-related services #2 may relate to hotels in New York with four-star and three-star ratings. Travel-related services #3 may relate to hotels with four-star and three-star ratings where the hotels are in New York City or within a radius of fifteen (15) miles from Times Square.

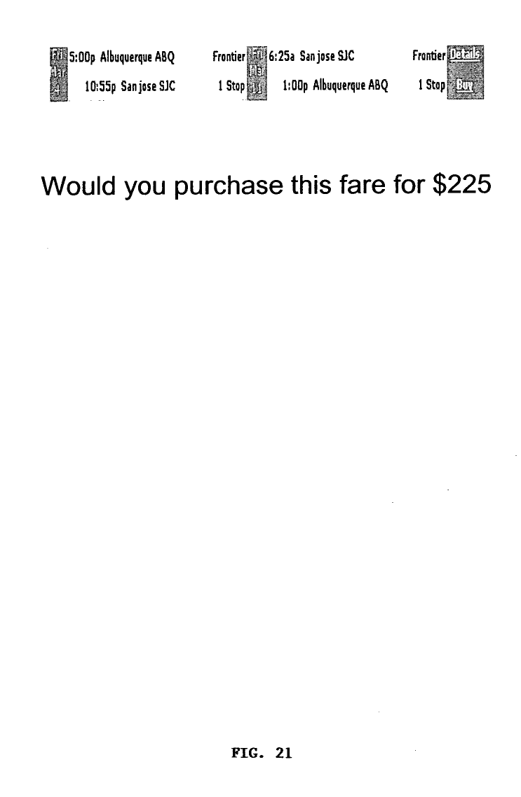

FIG. 19 provides additional information concerning Rule Engine #3. FIG. 21 includes a panel generally indicated at 2100. The panel 2100 includes terminals 2102, 2104, 2106, 2108, 2110, 2112, 2116, 2118 and 2120, respectively corresponding to terminals 2002, 2004, 2006, 2008, 2010, 2012, 2016, 2018 and 2020 in FIG. 18. A terminal 2122 is also provided to designate specific airlines such as United, Delta and Continental when American is the airline attempting to sell the passenger P a ticket by providing price and/or upgrade concessions to the passenger.

In FIG. 19, the vendor American sets (2124) the criteria through the web interface for the concessions to be made by American to the passenger P to sell the passenger an airline ticket. The discount amount to be provided by American for the flight is indicated at 2126. The discounted price to the passenger P is indicated at 2128. This discounted fare is designated at 2128 as the challenge fare.

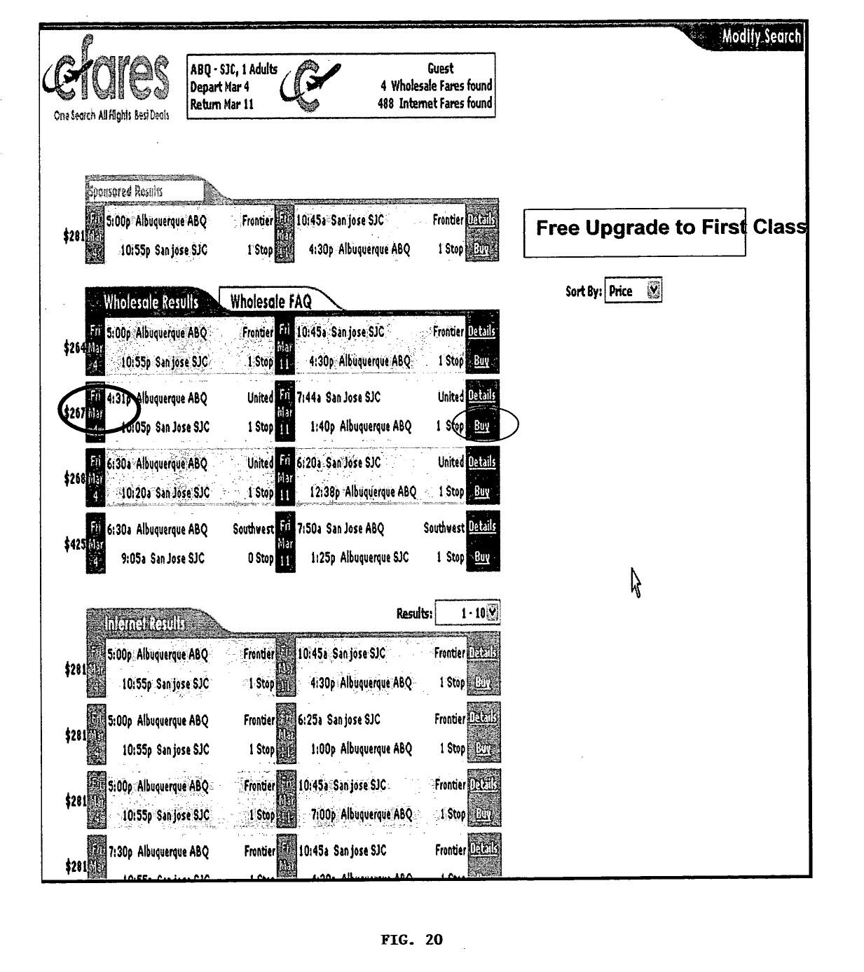

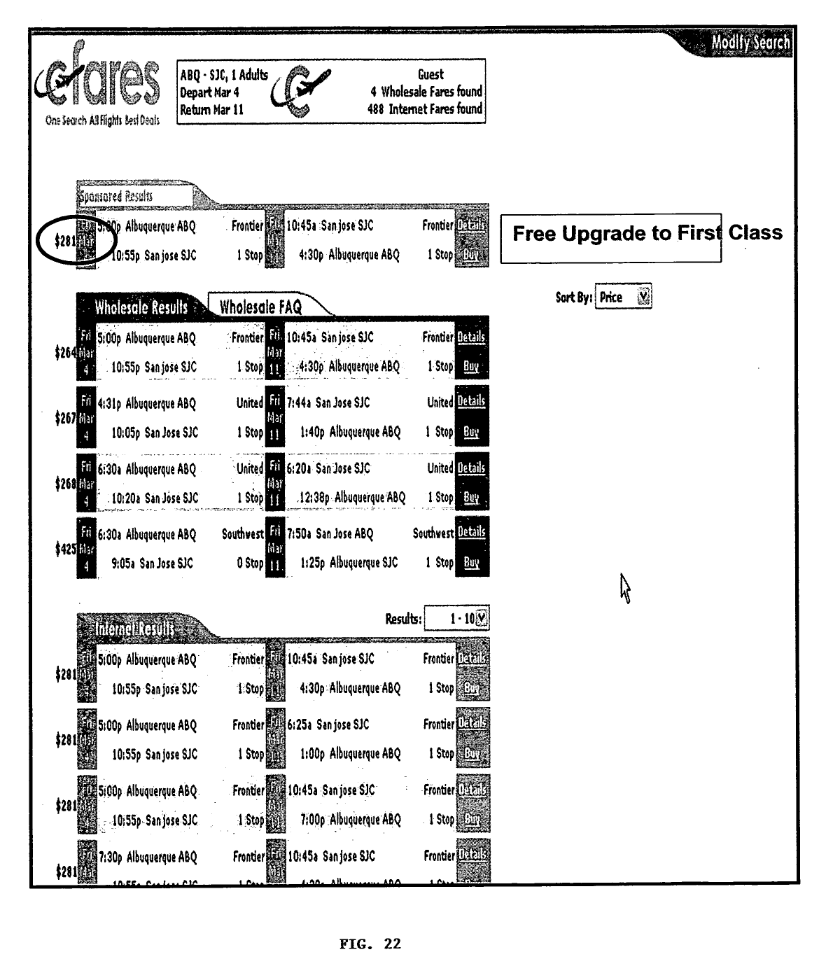

FIG. 20 indicates the intent of the passenger P to purchase a round-trip ticket on United Airlines for flights between Albuquerque, N. Mex. and San Jose, Calif. for a wholesale fare of $267. FIG. 21 indicates a challenge to the passenger P. It represents an offer to the passenger P to provide a round-trip ticket between San Jose and Albuquerque for $225 on Frontier Airlines. This offer may be made under rules engine #3. Alternatively, it may be under Rules Engine #1. FIG. 22 indicates an alternative proposal of Frontier Airlines to provide a round-trip ticket between Albuquerque and San Jose for the published fare of $281 with an upgrade to the passenger for a seat in the first class section of the airplane.

Although this invention has been disclosed and illustrated with reference to particular preferred embodiments, the principles involved are susceptible for use in numerous other embodiments which will be apparent to persons of ordinary skill in the art. The invention is, therefore, to be limited only as indicated by the scope of the appended claims.

What is claimed is:

1. A method of providing travel-related services to a recipient, including the steps of:
determining from the recipient parameters defining a proposed travel-related service to be provided to the recipient,
obtaining considerations through a wide area network from first competitors offering to perform the travel-related services in accordance with the parameters defined by the recipient,
obtaining considerations through the internet from second competitors offering to perform the travel-related services in accordance with the parameters defined by the recipient,
providing a display of the considerations offered by the first and second competitors for providing the travel-related services to the recipient,
determining from the display whether a selected one of the travel-related competitors is at a disadvantage relating to other competitors in the consideration to be provided by the recipient for the travel-related services, and
providing for a change in the consideration to be provided by the recipient to a selected one of the travel-related competitors to produce an advantage to the selected one of the travel-related competitors in performing the travel-related services to the recipient.

2. A method as set forth in claim 1 wherein
the travel-related services include a selected one of airline flights, boat trips, car rentals and hotel rooms.

3. A method as set forth in claim 1 wherein
the travel-related services constitute airline flights and the recipient is a passenger and the consideration involved in the travel-related service includes money payable to the selected one of the competitors and upgrades in the class of travel between coach, business class and first class and including frequent flyer miles provided to the passenger.

4. A method as set forth in claim 1 wherein
the travel-related services constitute airline flights and the recipient is a passenger and the consideration involved in the travel-related services includes money payable by the passenger for the travel-related services and a certificate provided by the selected one of the travel-related competitors to the passenger and redeemable by the passenger at the selected one of the travel-related services.

5. A method as set forth in claim 1 wherein
the travel-related service constitute airline flights and wherein the consideration for the travel-related services include upgrades offered by the travel-related services.

6. A method as set forth in claim 2 wherein
the travel-related services constitute airline flights and the recipient is a passenger and the consideration involved in the travel-related services include money payable to the selected one of the competitors and upgrades in the class of travel between coach, business class and first class and includes frequent flyer miles provided to the passenger and wherein
the consideration involved in the travel-related services includes money payable by the passenger for the travel-related services and a certificate provided by the selected one of the travel-related competitors to the passenger and redeemable by the recipient at the selected one of the travel-related services, and
the travel-related services constitute airline flights and wherein the consideration for the travel-related services include upgrades offered by the travel-related services.

7. A method of presenting a need of a customer for travel-related services and of presenting offers from suppliers for fulfilling such needs and providing acceptance of the travel-related services offered by one of the suppliers, including the steps of:
providing parameters defining the travel-related need of the customer,
listing on a display screen from a number of different suppliers a plurality of travel-related offers fulfilling the travel-related need of the customer,
providing for a commitment from a selected one of the suppliers to reduce the price of the offer from the selected one of the suppliers when the price quotation by another one of the suppliers is less than the price quotation from the selected one of the suppliers, and
reducing the price quotation from the selected one of the suppliers in accordance with the commitment of the selected one of the suppliers when the price quotation from the other one of the suppliers is less than the price quotation from the selected one of the suppliers.

8. A method as set forth in claim 7, including the step of:
providing to the customer a chit made payable to the customer in the amount of the reduction by the selected one of the suppliers when the customer accepts the offer of the selected one of the suppliers.

9. A method as set forth in claim 7 wherein
the parameters include, for an airline ticket, the scheduled places of departure and arrival and the scheduled stops between the places of the departure and arrival.

10. A method of presenting a need of a recipient for travel-related services and of presenting offers from suppliers to the recipient for fulfilling such needs and providing acceptance by the recipient of the travel-related services offered by a selected one of the suppliers including the steps of:
the travel-related services constitute airline flights and the consideration involved in the travel-related services include money payable by the recipient for the travel-related services and a certificate provided by the selected one of the travel-related competitors to the recipient and redeemable by the recipient at the selected one of the travel-related services,

11. A method as set forth in claim 7 wherein
the price quotation from the selected one of the suppliers to the recipient is reduced without the knowledge of the recipient when the initial price quoted by the selected one of the suppliers is above the price quoted by others of the suppliers and when the price quoted by the selected one of the suppliers with the price reduction is below the price quoted by the other ones of the suppliers.

12. A method as set forth in claim 7 wherein
the parameters include for an airline ticket the scheduled places of departure and arrival, the schedules times of departure and arrival and the number of scheduled stops between the places of departure and arrival and wherein
the price reduction by the selected one of the suppliers takes effect when the times for the departure and arrival are within particular time limits from the scheduled times requested by the passenger and there are less than a specified number of stops between the scheduled places of departure and arrival and when the prices quoted by the selected one of the suppliers and the other one of the suppliers for the airline flight are within particular limits of each other.

13. A method as set forth in claim 10 wherein
the travel-related services constitute airline flights and the consideration involved in the travel-related services include money payable to the selected one of the competitors and upgrades in the class of travel between coach, business class and first class and include frequent flyer miles provided to the passenger, and
the travel-related services constitute airline flights and wherein the consideration for the travel-related services include upgrades offered by the travel-related services to the passenger.

14. A method of presenting a need of a customer for a travel-related service, of providing offers from suppliers of travel-related services for fulfilling such need and of receiving acceptance from the customer for the travel-related service offered by the selected one of the suppliers, including the following steps:
providing parameters defining the travel-related need of the customer,
using wide area network techniques to provide offers from first suppliers for the travel-related need of the customer,
using internet techniques to provide offers from second suppliers different from the first suppliers to fulfill the travel-related need of the customer,
presenting the offers from the first and second suppliers to the customer is closely positioned relationship on a display screen,
receiving a prior authorization from the selected one of the first and second suppliers to reduce the price offered by the selected one of the suppliers for the travel-related service when the price offered by the selected one of the suppliers without any reduction in price is above the price offered by another one of the suppliers and the price offered by the selected one of the customers with the price reduction is below the price offered by the other one of the suppliers, and
reducing the price offered by the selected one of the suppliers for the travel-related service without any further authorization from the selected one of the suppliers when the reduced price from the selected one of the suppliers is below the price offered by the other one of the suppliers.

15. A method as set forth in claim 14 wherein
the customer pays the price offered by the selected one of the suppliers for the travel-related service before any reduction in the price by the related one of the suppliers, and
the selected one of the suppliers provides a certificate to the customer, corresponding to the dollar amount of the price reduction, for submission by the customer to the selected one of the suppliers for redemption by the selected one of the suppliers.

16. A method as set forth in claim 14 wherein
the selected one of the suppliers provides an upgrade to the customer without any further price reduction when the customer refuses to accept the travel-related service from the selected one of the suppliers with the price reduction.

17. A method as set forth in claim 1 including the step of:
receiving a prior authorization from the selected one of the suppliers to provide a further reduction in the price offered by the selected one of the suppliers for the travel-related service when the first price reduction offered to the customer by the selected one of the suppliers is refused by the customer and the upgrade offered to the customer by the selected one of the suppliers is refused by the customer.

18. A method of providing travel-related services to a recipient, including the steps of:
determining from the recipient parameters defining a proposed travel-related service to be provided to the recipient,
obtaining considerations through a wide area network from first competitors offering to perform the travel-related services in accordance with the parameters defined by the recipient,
obtaining considerations through the internet from second competitors offering to perform the travel-related services in accordance with the parameters defined by the recipient,
providing a display of the considerations offered by the first and second competitors for providing the travel-related services to the recipient,
determining from the display whether a selected one of the travel-related competitors is at a disadvantage relating to other competitors in the consideration to be provided by the recipient for the travel-related services, and
providing for a change in the consideration to be provided by the recipient to a selected one of the travel-related competitors to produce an advantage to the selected one of the travel-related competitors in performing the travel-related services to the recipient.

19. A method as set forth in claim 1 wherein
the travel-related services include a selected one of airline flights, boat trips, car rentals and hotel rooms.

20. A method as set forth in claim 1 wherein
the travel-related services constitute airline flights and the recipient is a passenger and the consideration involved in the travel-related service includes money payable to the selected one of the competitors and upgrades in the class of travel between coach, business class and first class and including frequent flyer miles provided to the passenger.

21. A method as set forth in claim 1 wherein
the travel-related services constitute airline flights and the recipient is a passenger and the consideration involved in the travel-related services includes money payable by the passenger for the travel-related services and a certificate provided by the selected one of the travel-related competitors to the passenger and redeemable by the passenger at the selected one of the travel-related services.

22. A method as set forth in claim 1 wherein
the travel-related service constitute airline flights and wherein the consideration for the travel-related services include upgrades offered by the travel-related services.

23. A method as set forth in claim 2 wherein
the travel-related services constitute airline flights and the recipient is a passenger and the consideration involved in the travel-related services include money payable to the selected one of the competitors and upgrades in the class of travel between coach, business class and first class and includes frequent flyer miles provided to the passenger and wherein
the consideration involved in the travel-related services includes money payable by the passenger for the travel-related services and a certificate provided by the selected one of the travel-related competitors to the passenger and redeemable by the recipient at the selected one of the travel-related services, and
the travel-related services constitute airline flights and wherein the consideration for the travel-related services include upgrades offered by the travel-related services.

24. A method of presenting a need of a customer for travel-related services and of presenting offers from suppliers for fulfilling such needs and providing acceptance of the travel-related services offered by one of the suppliers, including the steps of:
providing parameters defining the travel-related need of the customer,
listing on a display screen from a number of different suppliers a plurality of travel-related offers fulfilling the travel-related need of the customer,
providing for a commitment from a selected one of the suppliers to reduce the price of the offer from the selected one of the suppliers when the price quotation by another one of the suppliers is less than the price quotation from the selected one of the suppliers, and
reducing the price quotation from the selected one of the suppliers in accordance with the commitment of the selected one of the suppliers when the price quotation from the other one of the suppliers is less than the price quotation from the selected one of the suppliers.

25. A method as set forth in claim 7, including the step of:
providing to the customer a chit made payable to the customer in the amount of the reduction by the selected one of the suppliers when the customer accepts the offer of the selected one of the suppliers.

26. A method as set forth in claim 7 wherein
the parameters include, for an airline ticket, the scheduled places of departure and arrival and the scheduled stops between the places of the departure and arrival.

27. A method of presenting a need of a recipient for travel-related services and of presenting offers from suppliers to the recipient for fulfilling such needs and providing acceptance by the recipient of the travel-related services offered by a selected one of the suppliers including the steps of:
the travel-related services constitute airline flights and the consideration involved in the travel-related services include money payable by the recipient for the travel-related services and a certificate provided by the selected one of the travel-related competitors to the recipient and redeemable by the recipient at the selected one of the travel-related services,

28. A method as set forth in claim 7 wherein
the price quotation from the selected one of the suppliers to the recipient is reduced without the knowledge of the recipient when the initial price quoted by the selected one of the suppliers is above the price quoted by others of the suppliers and when the price quoted by the selected one of the suppliers with the price reduction is below the price quoted by the other ones of the suppliers.

29. A method as set forth in claim 7 wherein
the parameters include for an airline ticket the scheduled places of departure and arrival, the schedules times of departure and arrival and the number of scheduled stops between the places of departure and arrival and wherein
the price reduction by the selected one of the suppliers takes effect when the times for the departure and arrival are within particular time limits from the scheduled times requested by the passenger and there are less than a specified number of stops between the scheduled places of departure and arrival and when the prices quoted by the selected one of the suppliers and the other one of the suppliers for the airline flight are within particular limits of each other.

30. A method as set forth in claim 10 wherein
the travel-related services constitute airline flights and the consideration involved in the travel-related services include money payable to the selected one of the competitors and upgrades in the class of travel between coach, business class and first class and include frequent flyer miles provided to the passenger, and
the travel-related services constitute airline flights and wherein the consideration for the travel-related services include upgrades offered by the travel-related services to the passenger.

31. A method of presenting a need of a customer for a travel-related service, of providing offers from suppliers of travel-related services for fulfilling such need and of receiving acceptance from the customer for the travel-related service offered by the selected one of the suppliers, including the following steps:
providing parameters defining the travel-related need of the customer,
using wide area network techniques to provide offers from first suppliers for the travel-related need of the customer,
using internet techniques to provide offers from second suppliers different from the first suppliers to fulfill the travel-related need of the customer,
presenting the offers from the first and second suppliers to the customer is closely positioned relationship on a display screen,
receiving a prior authorization from the selected one of the first and second suppliers to reduce the price offered by the selected one of the suppliers for the travel-related service when the price offered by the selected one of the suppliers without any reduction in price is above the price offered by another one of the suppliers and the price offered by the selected one of the customers with the price reduction is below the price offered by the other one of the suppliers, and
reducing the price offered by the selected one of the suppliers for the travel-related service without any further authorization from the selected one of the suppliers when the reduced price from the selected one of the suppliers is below the price offered by the other one of the suppliers.

32. A method as set forth in claim 14 wherein
the customer pays the price offered by the selected one of the suppliers for the travel-related service before any reduction in the price by the related one of the suppliers, and
the selected one of the suppliers provides a certificate to the customer, corresponding to the dollar amount of the price reduction, for submission by the customer to the selected one of the suppliers for redemption by the selected one of the suppliers.

33. A method as set forth in claim 14 wherein
the selected one of the suppliers provides an upgrade to the customer without any further price reduction when the customer refuses to accept the travel-related service from the selected one of the suppliers with the price reduction.

34. A method as set forth in claim 1 including the step of:
receiving a prior authorization from the selected one of the suppliers to provide a further reduction in the price offered by the selected one of the suppliers for the travel-related service when the first price reduction offered to the customer by the selected one of the suppliers is refused by the customer and the upgrade offered to the customer by the selected one of the suppliers is refused by the customer.
